(19) United States
(12) Patent Application Publication
(10) Pub. No.: US 2017/0014776 A1
(43) Pub. Date: Jan. 19, 2017

(54) ANTI-FOULING MEMBRANES

(71) Applicant: NATIONAL UNIVERSITY OF SINGAPORE, Singapore (SG)

(72) Inventors: Xue LI, Singapore (SG); Tao CAI, Singapore (SG); Tai-Shung CHUNG, Singapore (SG)

(73) Assignee: NATIONAL UNIVERSITY OF SINGAPORE, Singapore (SG)

(21) Appl. No.: 15/207,632

(22) Filed: Jul. 12, 2016

Related U.S. Application Data
(60) Provisional application No. 62/231,720, filed on Jul. 13, 2015.

(51) Int. Cl. B01D 65/08; B01D 67/00; B01D 71/60; B01D 71/56; B01D 69/08; B01D 69/12; B01D 61/00

(52) U.S. Cl. CPC B01D 65/08; B01D 69/125; B01D 67/0006; B01D 61/002; B01D 71/56; B01D 69/08; B01D 71/60

(57) ABSTRACT

A membrane assembly is provided. The membrane assembly comprises a membrane having a first surface and an opposing second surface, and a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof arranged on the first surface of the membrane. A method of manufacturing a membrane assembly is also provided.

### CROSS-REFERENCE TO RELATED APPLICATION

This application claims the benefit of priority of U.S. provisional application No. 62/231,720 filed on 13 Jul. 2015, the content of which is incorporated herein by reference in its entirety for all purposes.

### TECHNICAL FIELD

Various embodiments relate to anti-fouling membranes, and methods of manufacturing the anti-fouling membranes.

### BACKGROUND

Membrane-based technologies, such as microfiltration, nanofiltration, ultrafiltration, forward osmosis, reverse osmosis, pressure retarded osmosis, gas separation, and pervaporation, have emerged as economical and highly energy-efficient alternatives to conventional technologies such as distillation and stripping in separation processes. Considerable interest has been generated in recent years to develop new materials and methods to improve both performance and antifouling properties of membranes, with objectives to establish maximum permeate flow and solute rejection while incurring minimum capital and operating costs.

Membrane lifetime and permeate fluxes may be affected by fouling phenomena as a result of microbial adhesion, gel layer formation and solute adhesion, for example, and concentration polarization in the form of solute build-up at the membrane surface. Accordingly, one way by which lifetime and permeate flux of a membrane may be improved is to control extent and/or likelihood of fouling on the membrane. Selection of an appropriate membrane, pretreatment of the process fluid, adjustment of operating design and conditions are factors which may be used to control fouling.

Of the types of separation processes mentioned above, pressure retarded osmosis (PRO) is of particular interest as it allows osmotic energy to be harvested from ocean and various sources of salt water, thereby providing an attractive, renewable, and environmentally friendly alternative to conventional fossil fuel.

Generally, during pressure retarded osmosis, a low salinity feed solution and a pressurized high salinity draw solution may be placed on opposite sides of a semi-permeable membrane. Osmotic energy may be produced when water in the low salinity feed solution permeates through the membrane and mixes with the pressurized high salinity draw solution. By depressurizing the resulting draw solution through a hydroturbine, for example, the produced osmotic energy may be transformed into electricity. Advantageously, pressure retarded osmosis offers high scalability, accessibility, and cost efficiency to effectively harvest osmotic energy into electricity. Most of early pressure retarded osmosis researches, however, were discontinued due to absence of effective membranes.

A successful pressure retarded osmosis process requires pressure retarded osmosis membranes with minimal fouling tendency, as membranes are generally prone to fouling due to its porous structure. Membrane fouling often occurs by the deposition and attachment of inorganic compounds, organic compounds, microorganisms and biomolecular foulants onto the membrane surface or even into the membrane pores, leading to pore clogging and permeability deterioration. Compared to conventional pressure-driven membrane processes, fouling on pressure retarded osmosis membranes, such as thin-film composite (TFC) pressure retarded osmosis membranes, is much more complicated because fouling may take place on the outer surface of selective layers, as well as both the outer and inner surfaces of support layers.

Therefore, to sustain the pressure retarded osmosis process, fouling on membranes must be reduced or mitigated. Even though fouling on the selective layers of the pressure retarded osmosis membrane may be reduced by using reverse osmosis (RO) retentate as the draw solution, reason being that the RO retentate has already been pretreated in its previous processes, in contrast thereto, fouling on the support layer cannot be avoided because water permeates from the feed solution (e.g., river water) to the draw solution (e.g., seawater or brine) introduces foulants on or into the porous support. State of the art methods to reduce fouling on the support layer such as pretreatment of feed solution, periodic cleaning, or surface modification of pressure retarded osmosis membranes are expensive and/or inadequate to meet the needs for pressure retarded osmosis (PRO).

In view of the above, there exists a need for an improved membrane and method for fabricating the membrane that overcome or at least alleviate one or more of the above problems.

### SUMMARY

In a first aspect, a membrane assembly is provided. The membrane assembly comprises

a) a membrane having a first surface and an opposing second surface, and
b) a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof arranged on the first surface of the membrane.

In a second aspect, a method of manufacturing a membrane assembly is provided. The method comprises

a) providing a membrane having a first surface and an opposing second surface, and
b) arranging a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof on the first surface of the membrane.

### BRIEF DESCRIPTION OF THE DRAWINGS

The invention will be better understood with reference to the detailed description when considered in conjunction with the non-limiting examples and the accompanying drawings, in which:

FIG. 1 is a schematic diagram showing synthesis route for a thiol-terminated hyper-branched polyglycerol (HPG-SH) of dendritic architecture according to an embodiment. It involves ring-opening polymerization of glycidol using bis(2-hydroxyethyl)disulfide (BHEDS) as initiator, followed by cleavage of the disulfide bond using excess DL-1,4-dithiothreitol (DTT) as reducing agent.

FIG. 2 is a schematic diagram showing procedure for fabrication of HPG-grafted polyether sulfone (PES) TFC hollow fiber membrane (HPG-g-TFC) membrane according to an embodiment. As depicted in the figure, modules of asymmetric PES hollow fiber membranes were fabricated. A HPG-SH solution was circulated in the shell side to allow reaction of HPG-SH with the polydopamine-modified support via Michael Addition to induce steric/enthalpic barrier against fouling. An ultrathin polyamide layer was deposited on the inner surface of hollow fibers via thin-film interfacial polymerization.

FIG. 3A is a scanning electron microscopy (SEM) image of an inner surface of a pristine PES hollow fiber support. Scale bar in the figure denotes 100 nm.

FIG. 3B is a scanning electron microscopy (SEM) image of an outer surface of a pristine PES hollow fiber support. Scale bar in the figure denotes 1 μm.

FIG. 3C is a scanning electron microscopy (SEM) image of a cross-section of a pristine PES hollow fiber support. Scale bar in the figure denotes 100 μm.

FIG. 3D is a scanning electron microscopy (SEM) image of a cross-section (inner portion) of a pristine PES hollow fiber support. Scale bar in the figure denotes 100 nm.

FIG. 3E is a scanning electron microscopy (SEM) image of a cross-section (outer portion) of a pristine PES hollow fiber support. Scale bar in the figure denotes 1 μm.

FIG. 4A is a scanning electron microscopy (SEM) image of an inner surface of pristine PES hollow fiber support. Scale bar in the figure denotes 100 nm.

FIG. 4B is a scanning electron microscopy (SEM) image of an outer surface of pristine PES hollow fiber support. Scale bar in the figure denotes 1 μm.

FIG. 4C is a scanning electron microscopy (SEM) image of an inner surface of PDA-PES hollow fiber support. Scale bar in the figure denotes 100 nm.

FIG. 4D is a scanning electron microscopy (SEM) image of an outer surface of PDA-PES hollow fiber support. Scale bar in the figure denotes 1 μm.

FIG. 4E is a scanning electron microscopy (SEM) image of an inner surface of PEG-g-PES hollow fiber support. Scale bar in the figure denotes 100 nm.

FIG. 4F is a scanning electron microscopy (SEM) image of an outer surface of PEG-g-PES hollow fiber support. Scale bar in the figure denotes 1 μm.

FIG. 4G is a scanning electron microscopy (SEM) image of an inner surface of HPG-g-PES hollow fiber support. Scale bar in the figure denotes 100 nm.

FIG. 4H is a scanning electron microscopy (SEM) image of an outer surface of HPG-g-PES hollow fiber support. Scale bar in the figure denotes 1 μm.

FIG. 5 shows X-ray photoelectron spectroscopy (XPS) wide scan, C 1s, S 2p, and N is core-level spectra of four hollow fiber membrane supports of PES, PDA-PES, PEG-g-PES, and HPG-g-PES.

FIG. 6 shows relative fluorescence intensities and respective fluorescence microscopy images of the PES, PDA-PES, PEG-g-PES, and HPG-g-PES hollow fiber membrane supports after exposure to 0.5 mg mL⁻¹ fluorescein isothiocynate conjugated bovine serum albumin protein solution (BSA-FITC) solution for 1 hour. Scale bar in the figure denotes 100 μm.

FIG. 7 shows antibacterial adhesion behavior of four membrane supports: (A) E. coli (ATCC DH5a); (B) S. aureus (ATCC 25923); (C) viable adherent fractions of E. coli and S. aureus cells in PBS (5×10⁷ cells mL⁻¹) in contact with four hollow fiber membrane supports of pristine PES, PDA-PES, PEG-g-PES, and HPG-g-PES at 37° C. for 4 hours. Scale bar in the figures denote 10 μm.

FIG. 8 shows cytotoxicity assays of different hollow fiber supports in 3T3 fibroblasts culture medium after 24 h of incubation. Error bars represent the standard deviation of four measurements.

FIG. 9 shows membrane performance in PRO tests using deionized water as the feed solution and 3.5% sodium chloride (NaCl) as the draw solution for TFC-PES, TFC-PEG, and TFC-HPG. The flow rates for both feed and draw solutions were 0.1 L min⁻¹.

FIG. 10A shows baseline tests of the TFC membranes of TFC-PES, TFC-PEG, and TFC-HPG in PRO. The normalized water flux decline is plotted against normalized permeate volume. The draw solution initially contained 3.5% NaCl, and deionized water was used as the feed solution. Hydraulic pressure difference between feed and draw solutions was 12.5±1 bar. The flow rates for both feed and draw solutions were 0.1 L min⁻¹.

FIG. 10B shows membrane fouling performance by dosing BSA as the foulants. The normalized water flux decline is plotted against normalized permeate volume. The draw solution initially contained 3.5% NaCl, and deionized water was used as the feed solution. Hydraulic pressure difference between feed and draw solutions was 12.5±1 bar. The flow rates for both feed and draw solutions were 0.1 L min⁻¹.

FIG. 11 is a schematic diagram showing back pulse effect. Foulants have accumulated within the porous support and beneath the dense layer in a fouled membrane. Some of them may be washed away during the cleaning, but some stay. In the high pressure PRO test, the pressurized draw solution suddenly impulses the dense layer from the lumen side, expands and stretches the hollow fiber radially outward, and loosens the foulants adhered or trapped within the membrane. More foulants are removed consequently.

FIG. 12A shows synthesis route for P[DMAPS-co-DMEL] random copolymer according to an embodiment.

FIG. 12B shows synthesis route for P[MPC-co-DMEL] random copolymer according to an embodiment.

FIG. 13A shows ¹H NMR spectra of P[DMAPS-co-MEL] (entry DM2 in TABLE 2).

FIG. 13B shows ¹H NMR spectra of P[DMAPS-co-DMEL] (prepared from entry DM2 in TABLE 2) random copolymers in D₂O.

FIG. 14 shows a schematic procedure for fabrication of TFC-g-P[DMAPS-co-DMEL], and TFC-g-P[MPC-co-DMEL] membranes.

FIG. 15 shows XPS widescan, C 1s, N 1s, P 2p and S 2p core-level spectra of (a) PES, (b) PES-PDA, (c) PES-g-P [DMAP S-co-DMEL], and (d) PES-g-P[MPC-co-DMEL] hollow fibers.

FIG. 16 shows SEM images of outer surfaces and cross-section (outer edge) of (a) PES, (b) PES-g-P[DMAPS-co-DMEL] and (c) PES-g-P[MPC-co-DMEL] hollow fibers.

FIG. 17 shows relative fluorescence intensities and respective fluorescence microscopy images of (a) PES, (b) PES-PDA, (c) PES-g-P[DMAPS-co-DMEL], and (d) PES-g-P[MPC-co-DMEL] hollow fibers after exposure to 0.5 mg/mL BSA-FITC solution for 2 h. Scale bar in the figures denote 100 μm.

FIG. 18 shows SEM images of outer surfaces (A) and viable adherent fractions (B) of (a) PES, (b) PES-PDA, (c) PES-g-P[DMAPS-co-DMEL] and (d) PES-g-P[MPC-co-DMEL] hollow fibers after exposure to S. epidermidis (top) and E. coli (below) at an initial cell concentration of 5×10⁷ cells/mL for 4 h at 37° C. The cell number was determined by the spread plate method.

FIG. 19 shows cytotoxicity assays of (a) PES, (b) PES-PDA, (c) PES-g-P[DMAPS-co-DMEL], and (d) PES-g-P[MPC-co-DMEL] hollow fibers in 3T3 fibroblasts culture medium after 24 h of incubation. Error bars represent the standard deviation of four measurements.

FIG. 20 is a graph comparing membrane fouling performance of TFC-g-P[DMAPS-co-DMEL], TFC-g-P[MPC-co-DMEL], and TFC-PES by using wastewater as feed. The normalized water flux decline is plotted against testing time. The draw solution initially contained 1 M NaCl, and wastewater was used as the feed solution. Hydraulic pressure difference between feed and draw solutions was 10±0.5 bar.

FIG. 21 shows XPS wide scan, C 1s, S 2p core-level spectra of CHPG grafted hollow fiber membrane.

FIG. 22 shows relative fluorescence intensities and respective fluorescence microscopy images of PES, and PES-g-CHPG grafted hollow fiber membrane supports after exposure to 0.5 mg mL⁻¹ BSA-FITC solution for 1 h. Scale bar in the figures denote 100 μm.

FIG. 23 shows SEM images of outer surfaces (A) and viable adherent fractions (B) of (a) PES and (b) PES-g-CHPG hollow fibers after exposure to S. aureus (top) and E. coli (below) at an initial cell concentration of 5×10⁷ cells/mL for 4 h at 37° C. The cell number was determined by the spread plate method. Scale bar in the figures denote 10 μm.

FIG. 24 shows membrane fouling performance in wastewater PRO process according to embodiments.

FIG. 25A shows ¹H NMR spectra of MEL monomer in CDCl₃.

FIG. 25B shows ¹H NMR spectra of P[MPC-co-MEL] (entry MM2 in TABLE 3) random copolymers in D₂O.

FIG. 25C shows ¹H NMR spectra of P[MPC-co-DMEL] (prepared from entry MM2 in TABLE 3) random copolymers in D₂O.

### DETAILED DESCRIPTION

Various embodiments refer in a first aspect to a membrane assembly. Advantageously, a membrane assembly according to embodiments disclosed herein is able to alleviate fouling through surface modification of membranes via molecular design. In so doing, bulk properties of the membrane are not affected.

For example, anti-fouling thin-film composite (TFC) membranes have been prepared by synthesizing a hyperbranched polyglycerol (HPG), which is a dendritic hydrophilic polymer with well-controlled grafting sites, and then grafting it on a membrane support. The membrane assembly has demonstrated markedly improved fouling resistance against bovine serum albumin (BSA) adsorption, E. coli adhesion, and S. aureus attachment. In high-pressure pressure retarded osmosis tests, a membrane assembly disclosed herein has demonstrated improved water flux and power density, and enhanced flux recovery of up to 94% after cleaning and hydraulic pressure impulsion, which is difficult to achieve using conventional membranes.

As another example, anti-fouling thin-film composite (TFC) membranes have also been prepared by synthesizing zwitterionic copolymers of 2-methacryloyloxyethyl lipoate (MEL) and [2-(methacryloyloxy)ethyl]dimethyl-(3-sulfopropyl) ammonium hydroxide (DMAPS), or 2-methacryloyloxy ethyl lipoate (MEL) and 2-methacryloyloxyethylphosphorylcholine (MPC), and grafting the copolymers on a membrane support. The membrane grafted with the superhydrophilic PDMAPS and PMPC brushes exhibited improved fouling resistance to protein and bacterial adhesion, and to biofilm formation, with minimum alteration of their morphology and bulk properties. Non-specific protein adsorption from single protein solutions may be reduced with greater effectiveness as compared to polyethylene glycol (PEG) modified surfaces. Non-toxicity of the modified membranes was also confirmed using cytotoxicity experiments.

By grafting the anti-fouling polymer to the membrane support to form a membrane assembly, extent and/or likelihood of fouling of the membrane assembly may be reduced, thereby improving membrane lifetime and permeate flux through the membrane. The membrane assembly and method of manufacturing a membrane assembly disclosed herein may be used in all types of membrane applications, such as, but not limited to, microfiltration, nanofiltration, ultrafiltration, forward osmosis, reverse osmosis, pressure retarded osmosis, gas separation, and pervaporation. Furthermore, the method disclosed herein is versatile as it is suitable for a wide range of substrates, and may be adapted readily for modifying conventional membranes to provide or to improve on anti-fouling properties.

With the above in mind, various embodiments refer in a first aspect to a membrane assembly. The membrane assembly comprises a membrane having a first surface and an opposing second surface, and a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof arranged on the first surface of the membrane.

As used herein, the term “membrane” refers to a semi-permeable material that selectively allows certain species to pass through it while retaining others within or on the material. A membrane therefore functions like a filter medium to permit a component separation by selectively controlling passage of the components from one side of the membrane to the other side. Examples of membrane types include hollow fiber membranes, flat-sheet membranes, spiral wound membranes, or tubular membranes. Flat-sheet membranes are formed from one or more sheets of membrane material placed adjacent to or bonded to one another. Spiral wound membranes are flat sheet membranes which are wrapped around a central collection tube. Tubular membranes and hollow fiber membranes assume the form of hollow tubes of circular cross-section, whereby the wall of the tube functions as the membrane.

Generally, the membrane may be formed from any suitable organic or inorganic material. For example, the membrane may comprise a material selected from the group consisting of polyethersulfone, polysulfone, polyvinylidene fluoride, cellulose acetate, matrimid, Torlon, polyetherimide, polyacrylonitrile, ceramic materials, and combinations thereof. In some embodiments, the membrane is formed from a polymer. Examples of suitable polymers include, but are not limited to, polyarylether sulfones such as polysulfone (PSF) and polyether sulfone (PES), polyimides such as polyetherimide (PEI), polyacrylonitrile (PAN), polyvinylidene fluoride (PVDF), combination thereof or derivatives thereof. In one embodiment, the membrane is made of polyether sulfone (PES).

The membrane has a first surface and opposing second surface. The term “opposing” as used herein is used to describe an orientation of the second surface with respect to the first surface, whereby the second surface is positioned on a reverse or opposite side to the first surface. A layer of anti-fouling polymer is arranged on the first surface of the membrane. As used herein, the term “fouling” refers to the deposition and attachment of inorganic compounds, organic compounds, microorganisms and biomolecular foulants onto the membrane surface or into the membrane pores, leading to pore clogging and permeability deterioration. Accordingly, the term “anti-fouling” refers to the effect of preventing, reducing, and/or eliminating fouling.

The anti-fouling polymer arranged on the first surface of the membrane is selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof.

In various embodiments, the anti-fouling polymer comprises or is composed entirely of an optionally functionalized hyperbranched polyglycerol. Advantageously, well-designed dendrimers or hyperbranched polymers such as the hyperbranched polyglycerol disclosed herein may exhibit distinct advantages of properly planting on membrane surface with controllable shielding sizes and multiplied antifouling effects. This compares favorably against linear polymers or co-polymers, such as polyethylene glycol, which may block surface pores and decrease permeability due to presence of non-controllable and randomly curly polymer chains. Furthermore, reduction in anti-fouling properties of polyethylene glycol may result from long term usage due to oxidative degradation of the polyethylene glycol chains.

In various embodiments, the anti-fouling polymer is a hyperbranched polyglycerol. Advantageously, a hyperbranched polyglycerol may be synthesized with a controlled molecular weight, narrow polydispersity index and well-preserved end group functionality. The hyperbranched polyglycerol is obtainable by reacting glycidol with a disulfide initiator to form a polymer, and reacting the polymer with a reducing agent to form the hyperbranched glycerol. Polymerization of the glycidol may take place via a ring-opening mechanism with a disulfide initiator such as bis(2-hydroxyethyl)disulfide, and in the presence of a catalyst such as sodium methoxide, NaOCH₃, which is a strong base. The polymer thus formed may be reduced with a reducing agent such as DL-1,4-dithiothreitol, which may be present in an excess amount, such that the disulfide bond of the polymer is cleaved to obtain the hyperbranched glycerol.

In some embodiments, the hyperbranched polyglycerol is a functionalized hyperbranched polyglycerol. Functionalization of hyperbranched polymers may be conducted to vary or to adjust the anti-fouling performance. For example, the hyperbranched polyglycerol may be a functionalized hyperbranched polyglycerol comprising a functional group selected from the group consisting of a carboxylic group, a sulfonate group, a phosphate group, a quaternary ammonium group, a phosphonium group, and combinations thereof. Accordingly, the functionalized hyperbranched polyglycerol may be a carbonated hyperbranched polyglycerol, a sulfonated hyperbranched polyglycerol, a phosphorylated hyperbranched polyglycerol, a hyperbranched polyglycerol with quaternary ammonium ending groups or a hyperbranched polyglycerol with phosphonium ending groups.

In specific embodiments, the hyperbranched polyglycerol comprises or is composed entirely of a carbonated hyperbranched polyglycerol.

In an embodiment, the hyperbranched polyglycerol has a structure as depicted in general formula (I)

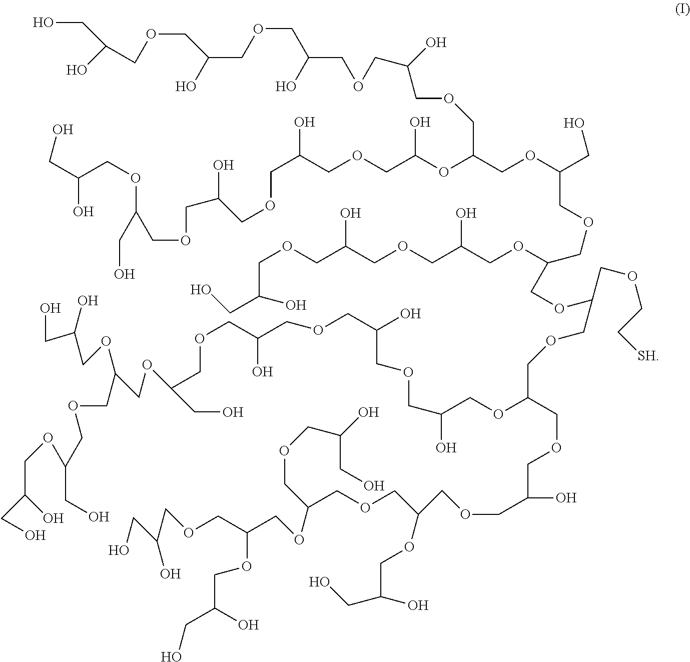

The optionally functionalized hyperbranched polyglycerol may have a number average molecular weight (Mₙ) that is greater than about 5000 g mol⁻¹. The number average molecular weight may be obtained by dividing the weight of a sample by the number of molecules of which it is composed. For example, the optionally functionalized hyperbranched polyglycerol may have a number average molecular weight (Mₙ) in the range of about 5000 g mol⁻¹ to about 8000 g mol⁻¹, about 5000 g mol⁻¹ to about 7000 g mol⁻¹, about 6000 g mol⁻¹ to about 7000 g mol⁻¹, or about 6100 g mol⁻¹.

In addition to, or apart from an optionally functionalized hyperbranched polyglycerol, the anti-fouling polymer may comprise or be composed entirely of a zwitterionic polymer or copolymer. As used herein, the term “zwitterionic polymer” or similar terms refer to a polymer comprising substantially equal or equal numbers of positively and negatively charged groups within the same repeating units. Due to the equal number of positively and negatively charged groups, overall charge on the zwitterionic polymer may be zero.

As disclosed herein, the anti-fouling polymer comprises a zwitterionic copolymer obtainable by polymerizing 2-methacryloyloxyethyl lipoate with at least one of [2-(methacryloyloxy)ethyl] dimethyl-(3-sulfopropyl) ammonium hydroxide or 2-methacryloyloxyethylphosphorylcholine, and combinations thereof arranged on the first surface of the membrane. The term “copolymer” refers to polymers formed by the polymerization reaction of at least two different monomers. Accordingly, the anti-fouling polymer may be a zwitterionic copolymer of 2-methacryloyloxyethyl lipoate (MEL) and [2-(methacryloyloxy)ethyl]dimethyl-(3-sulfopropyl) ammonium hydroxide (DMAPS), or a zwitterionic copolymer of 2-methacryloyloxyethyl lipoate (MEL) and 2-methacryloyloxyethylphosphorylcholine (MPC). In various embodiments, the zwitterionic copolymer is a zwitterionic random copolymer.

Advantageously, introduction of 2-methacryloyloxyethyl lipoate (MEL) components into the zwitterionic copolymer provides sufficient grafting sites to allow immobilizing of the zwitterionic copolymer onto the membrane surface. The zwitterionic copolymers of 2-methacryloyloxyethyl lipoate (MEL) and [2-(methacryloyloxy)ethyl]dimethyl-(3-sulfopropyl) ammonium hydroxide (DMAPS), or 2-methacryloyloxyethyl lipoate (MEL) and 2-methacryloyloxyethylphosphorylcholine (MPC) have been shown herein to be effective in reducing protein adsorption and bacterial adhesion on membranes.

The zwitterionic copolymers are obtainable by a reversible additional-fragmentation chain transfer (RAFT) polymerization of zwitterionic monomers such as [2-(methacryloyloxy)ethyl]dimethyl-(3-sulfopropyl) ammonium hydroxide (DMAPS) and/or 2-methacryloyloxyethylphosphorylcholine (MPC), and a disulfide-containing monomer such as 2-methacryloyloxyethyl lipoate (MEL). The RAFT polymerization may be carried out in the presence of a RAFT agent such as 4-cyano-4-(phenylcarbonothioylthio)pentanoic acid (CTP), and an initiator such as 2,2′-azobis(2-methylpropionitrile) (AIBN). The polymer thus formed may be reduced with a reducing agent such as sodium borohydride (NaBH₄), which may be present in an excess amount, such that the disulfide bond of the polymer is cleaved to obtain the zwitterionic copolymer.

The zwitterionic copolymer may have a number average molecular weight (Mₙ) in the range of about 15000 g mol⁻¹ to about 40000 g mol⁻¹, such as about 17000 g mol⁻¹ to about 30000 g mol⁻¹, or about 21000 g mol⁻¹ to about 38000 g mol⁻¹.

The layer of anti-fouling polymer arranged on the first surface of the membrane may have a thickness of less than 30 nm. For example, the layer of anti-fouling polymer arranged on the first surface of the membrane may have a thickness in the range of about 1 nm to 30 nm, about 5 nm to 30 nm, about 10 nm to 30 nm, about 15 nm to 30 nm, about 20 nm to 30 nm, about 1 nm to 20 nm, about 1 nm to 10 nm, or about 10 nm to 20 nm.

In various embodiments, the membrane assembly further comprises a linking layer arranged between the membrane and the layer of anti-fouling polymer for immobilizing the layer of anti-fouling polymer to the membrane. For example, the linking layer may be arranged between the membrane and the layer of anti-fouling polymer such that it is directly contacting the membrane and the anti-fouling polymer. The linking layer may, for example, comprise a compound that may be immobilized on a surface of the membrane, and is able to react with a thiol group.

In some embodiments, the linking layer comprises or is composed entirely of polydopamine. Polydopamine refers to a polymer formed by the polymerization of dopamine, where dopamine is a molecule containing amine and catechol functional groups and having the following formula:

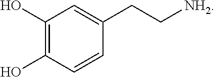 [SMILES: NCCc1ccc(O)c(O)c1]

When dopamine is subjected to a slightly basic condition, it is able to self-polymerize to form thin adherent polydopamine (PDA) films on a variety of material surfaces due to presence of the catechol functional groups. In particular, the catechol functional groups on polydopamine are able to react with amine or thiol groups which may be present on material surfaces to form covalent bonding via Michael addition. In cases where amine or thiol groups are not present, polydopamine may nevertheless still be able to adhere to the material surfaces via non-covalent interactions such as metal coordination or chelating, hydrogen bonding and/or π-π stacking.

In embodiments where the anti-fouling polymer comprises an optionally functionalized hyperbranched polyglycerol disclosed herein, the optionally functionalized hyperbranched polyglycerol may be grafted to or immobilized on the linking layer comprising polydopamine via Michael addition.

In embodiments where the anti-fouling polymer comprises a zwitterionic copolymer disclosed herein, the zwitterionic copolymer may be grafted to or immobilized on the linking layer comprising polydopamine via Michael addition.

The approach described above may be seen as a “grafting to” approach, since a prefabricated polymer with defined functionalities is covalently linked to the substrates. This contrasts with the “grafting from” approach, whereby the polymer layer is constructed in situ by chain propagation through successive addition of monomer units from initiating sites on the surface.

Even though the “grafting from” approach may exhibit a higher grafting efficiency due to reduced steric hindrance to diffusion of small monomers, this is more than compensated by improved control of surface properties of the “grafting to” approach, as molecular parameters of the prefabricated polymers applied may be thoroughly characterized in terms of molecular weight, molecular weight distribution and other physicochemical properties prior to conjugation. Furthermore, specific functional polymers that are inaccessible by direct polymerization methods are rendered possible by the “grafting to” approach.

The linking layer may have a thickness of less than 20 nm. For example, the linking layer may have a thickness in the range of about 1 nm to 20 nm, about 5 nm to 20 nm, about 10 nm to 20 nm, about 1 nm to 15 nm, about 1 nm to 10 nm, or about 5 nm to 15 nm.

In various embodiments, the membrane assembly further comprises a polyamide layer arranged on the second surface of the membrane. The polyamide layer may be cross-linked to provide a thin and dense barrier to solutes, but having a lower resistance to water. The polyamide layer is obtainable by interfacial polymerization of a polyfunctional amine, such as m-phenylenediamine (MPD), in an aqueous phase such as water, and a polyfunctional acyl chloride, such as 1,3,5-benzenetricarbonyl trichloride (TMC) in an organic phase such as n-hexane. Advantageously, the polyamide layer thus formed may have a very high solute rejection capability in excess of 98%, with reasonably high water flux. Furthermore, the polyamide layer may be durable, and resistant to compression and degradation by pH and/or temperature.

Thickness of the polyamide layer may be in the range of about 10 nm to about 100 nm, such as about 10 nm to about 80 nm, about 10 nm to about 60 nm, about 10 nm to about 50 nm, about 20 nm to about 100 nm, about 40 nm to about 100 nm, about 30 nm to about 80 nm, or about 25 nm to about 75 nm.

The membrane may be a multi-layer hollow fiber membrane, and the layer of anti-fouling polymer may form an outer layer of the multi-layer hollow fiber membrane. In various embodiments, the multi-layer hollow fiber membrane is prepared by a co-extrusion technique using a dual layer spinneret, such as that exemplified in Example 2 disclosed herein.

For example, the multi-layer hollow fiber membrane may be prepared by extruding a bore liquid through an inner channel of the dual layer spinneret; extruding an inner doping liquid through a middle channel of the dual layer spinneret; and extruding an outer doping liquid through an outer channel of the dual layer spinneret.

The bore liquid may be an aqueous solution such as water, and may have a flow rate in the range of about 0.1 mL/min to about 3.0 mL/min, such as about 1 mL/min. The inner doping liquid may comprise a polymer such as polyether sulfone for forming the membrane, and which is dissolved in a suitable solvent such as n-methyl-2-pyrrolidone (NMP). Ethylene glycol, and/or poly(ethylene glycol) (PEG) and/or water may also be added into the dope as additives. Flow rate of the inner doping liquid may be in the range of about 0.5 mL/min to about 3.0 mL/min, such as about 1.8 mL/min. The outer doping liquid may be a suitable solvent such as n-methyl-2-pyrrolidone (NMP), and may have a flow rate in the range of about 0.01 mL/min to about 1.0 mL/min such as about 0.1 mL/min.

Co-extrusion with a dual layer spinneret may be carried out at any suitable temperature. Advantageously, the co-spinning may be carried out at a temperature in the range of about 0° C. to about 60° C., such as ambient temperature.

Co-extrusion with a dual layer spinneret may be carried out at any suitable humidity. Advantageously, the co-spinning may be carried out at humidity in the range of about 20% to about 95%, such as ambient humidity.

The multi-layer hollow fiber membrane thus formed may have an asymmetric cross-section made up of three distinct regions. For example, the multi-layer hollow fiber membrane may contain “sponge-like” porous inner and outer layers, the outer layer having a porosity greater than that of the inner layer, and an intermediate layer having “finger-like” elongated macrovoids arranged between the inner layer and the outer layer.

The membrane assembly disclosed herein may be used in a wide range of applications, such as osmotic power generation via pressure retarded osmosis, water treatments via forward osmosis, nanofiltration, and reverse osmosis, in various industries such as dye, pharmaceutical, and desalination. As mentioned above, the membrane assembly disclosed herein may be used in all types of membrane applications, such as, but not limited to, microfiltration, nanofiltration, ultrafiltration, forward osmosis, reverse osmosis, pressure retarded osmosis, gas separation, and pervaporation. In some embodiments, the membrane assembly disclosed herein may be used for producing osmotic energy in pressure retarded osmosis. Advantageously, due to reduction in extent and/or likelihood of fouling on the membrane, membrane lifetime and permeate flux through the membrane assembly may be sustained for power generation using pressure retarded osmosis.

Various embodiments refer in a second aspect to a method of manufacturing a membrane assembly. The method comprises providing a membrane having a first surface and an opposing second surface, and arranging a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof on the first surface of the membrane.

In various embodiments, providing the membrane comprises depositing a linking layer for immobilizing the anti-fouling polymer on a first surface of the membrane. Examples of the linking layer have already been discussed above. In some embodiments, the linking layer comprises or is composed entirely of polydopamine.

Arranging the layer of anti-fouling polymer on the first surface of the membrane may comprise depositing the layer of anti-fouling polymer under conditions to immobilize the layer of anti-fouling polymer on the linking layer.

As mentioned above, in embodiments where the anti-fouling polymer comprises an optionally functionalized hyperbranched polyglycerol disclosed herein, the optionally functionalized hyperbranched polyglycerol may be grafted to or immobilized on the linking layer comprising polydopamine via Michael addition, whereas in embodiments where the anti-fouling polymer comprises a zwitterionic copolymer disclosed herein, the zwitterionic copolymer may be grafted to or immobilized on the linking layer comprising polydopamine via Michael addition. A person skilled in the art is able to determine the conditions suitable for immobilizing an anti-fouling polymer from the disclosure and examples provided herein.

In various embodiments, providing the membrane comprises forming a polyamide layer on the second surface of the membrane. As discussed above, forming the polyamide layer may be carried out by interfacial polymerization of a polyfunctional amine, such as m-phenylenediamine (MPD), in an aqueous phase such as water, and a polyfunctional acyl chloride, such as 1,3,5-benzenetricarbonyl trichloride (TMC) in an organic phase such as n-hexane.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

Various embodiments disclose the fabrication of anti-fouling membranes by grafting suitable polymers on or throughout the membrane substrate. At least a partial surface, or an entire surface of the membrane substrate may be grafted with the polymers. Suitable polymers may include using co-polymers, dendrimers, or hyperbranched polymers. Functionalization of hyperbranched polymers may optionally be conducted to vary or to adjust the anti-fouling performance. Well-designed dendrimers or hyperbranched polymers show distinct advantages of properly planting on membrane surface with controllable shielding sizes and multiplied antifouling effects. Advantageously, problems relating to reduced permeability resulting from pores blockage due to use of a linear polymer such as polyethylene glycol may be eliminated or alleviated. As such, grafting a hyperbranched hydrophilic polymer onto the membrane surface to increase the fouling resistance of the membrane may be more effective than using linear polymers.

The grafting route according to embodiments disclosed herein provides a uniquely properly-controlled way to form a monolayer of the dendritic polymer on a wide range of substrates. Such a dendritic monolayer structure effectively covers the surface of substrates and prevents pore blockage. A linker may optionally be used on the membrane surface for the hyperbranched polymer to be grafted.

In various embodiments, a hyper-branched polyglycerol (HPG) was used as it may be synthesized with a controlled molecular weight, narrow polydispersity index and well-preserved end group functionality by ring-opening polymerization of glycidol with the aid of a strong base (Sodium Methoxide, NaOCH₃) and a co-initiator (amine or hydroxyl group).

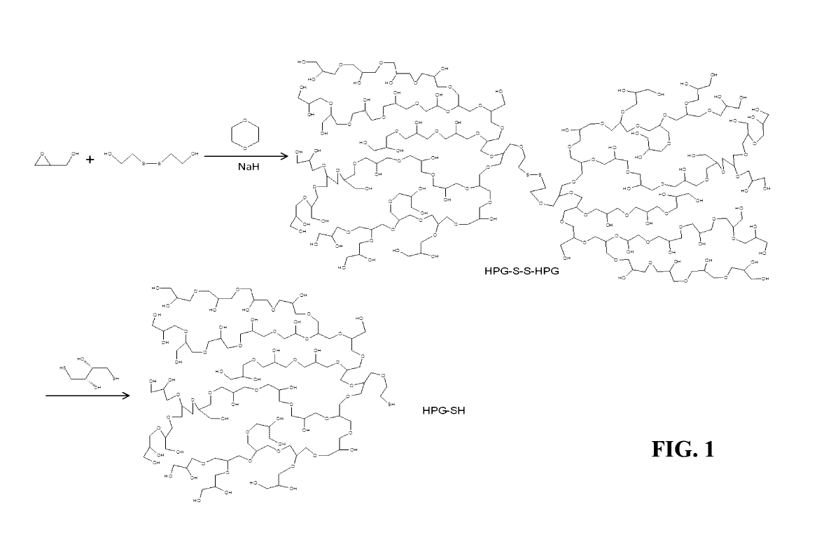

FIG. 1 illustrates the synthesis route for a thiol terminated hyper-branched polyglycerol (HPG-SH) of dendritic architecture according to an embodiment. It involves ring-opening polymerization of glycidol using bis(2-hydroxyethyl)disulfide (BHEDS) as the initiator, followed by cleavage of the disulfide bond using excess DL-1,4-dithiothreitol (DTT) as the reducing agent. To the best of the inventors' knowledge, grafting HPG-SH on polydopamine-modified PRO membranes has never been proposed. This pioneering work may provide useful insight on novel PRO membranes with fouling resistance for osmotic power generation.

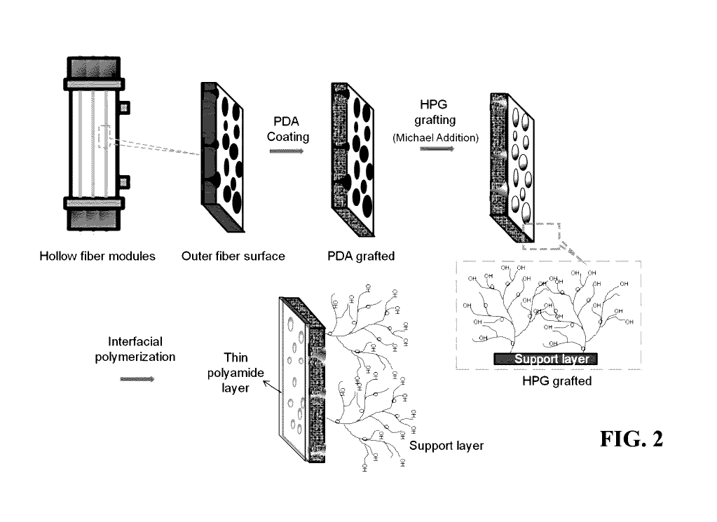

FIG. 2 illustrates a step-by-step procedure to fabricate the HPG grafted thin-film composite (TFC) hollow fiber membranes according to an embodiment: (1) modules consisting of asymmetric hollow fiber membranes were fabricated; (2) a HPG-SH solution was circulated in the shell side so that HPG-SH would react with the polydopamine (PDA) modified support via Michael addition to induce steric/enthalpic barrier against fouling; (3) an ultra-thin polyamide was deposited on the inner surface of hollow fibers via thin-film interfacial polymerization.

In embodiments, the inventors have compared the performance of the hollow fiber membranes grafted with anti-fouling hyperbranched polymers with hollow fiber membranes without the anti-fouling polymer layer. Compared to the pristine hollow fiber membranes, the membranes grafted with hyperbranched polymers show much superior fouling resistance against bovine serum albumin (BSA) adsorption, E. coli adhesion, and S. aureus attachment. In high pressure PRO tests, the pristine membranes are badly fouled by model protein foulants, causing a water flux decline of 31%. In comparison, the grafted membrane not only has an inherently higher water flux and a higher power density but also exhibits better flux recovery up to 94% after cleaning and hydraulic pressure impulsion.

In another embodiment, the inventors have compared the performance of the hollow fiber membranes grafted with a co-polymer with hollow fiber membranes without the anti-fouling polymer layer. Compared to the pristine hollow fiber membranes, the membranes grafted with co-polymers show much superior fouling resistance against bovine serum albumin (BSA) adsorption, E. coli adhesion, and S. aureus attachment. In high pressure PRO tests, the pristine membranes are badly fouled by concentrated wastewater, causing a water flux decline of 61%. In comparison, the grafted membranes have lower reductions in water flux of 27.5% to 28.5% in the concentrated wastewater tests.

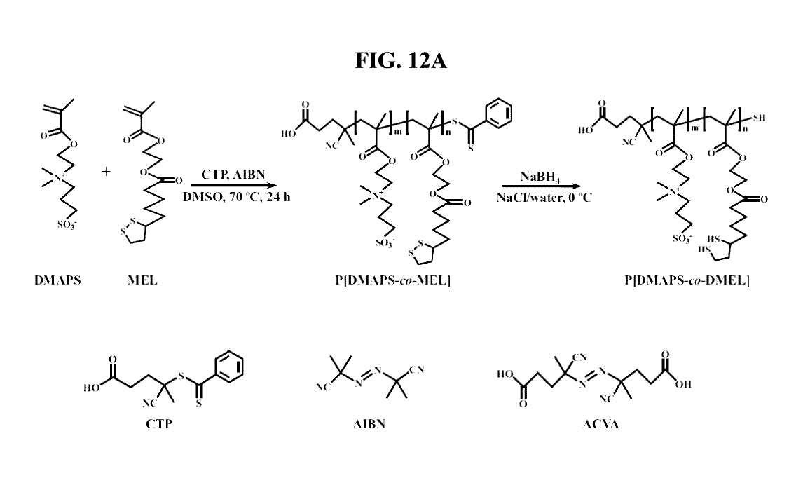

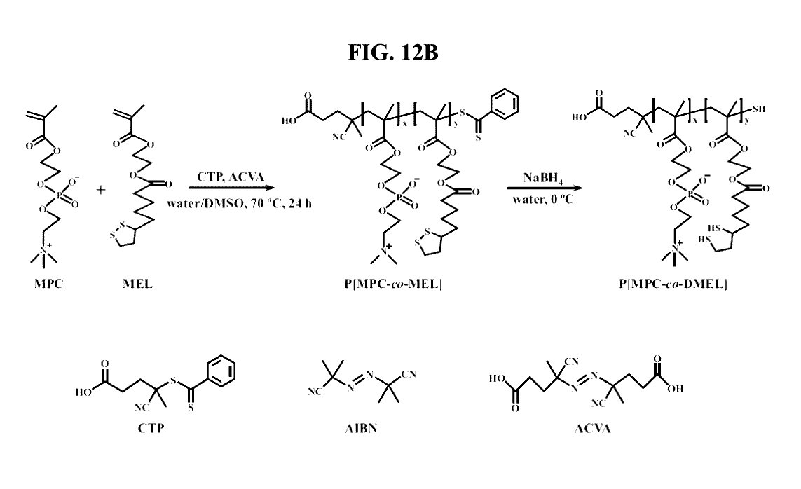

In further embodiments, a simple and versatile means for the surface modification of PRO membranes via the “grafting to” method and a new and effective anti-fouling strategy by grafting zwitterionic copolymers onto the PRO membrane surfaces is disclosed. FIG. 12A and FIG. 12B illustrate the synthetic routes of two zwitterionic copolymers. It involves reversible addition-fragmentation chain transfer (RAFT) polymerization of a zwitterionic monomer, either [2-(methacryloyloxy)ethyl]dimethyl-(3-sulfo-propyl)ammoniumhydroxide (DMAPS) or 2-methacryloyloxyethyl phosphorylcholine (MPC) and a disulfide-containing monomer, 2-methacryloyloxyethyl lipoate (MEL) in the presence of 4-cyano-4-(phenylcarbonothioylthio)pentanoic acid (CTP) as the RAFT agent and 2,2′-azobis(2-methylpropionitrile) (AIBN) as the initiator, followed by cleavage of the disulfide groups using excess NaBH₄ as the reducing agent.

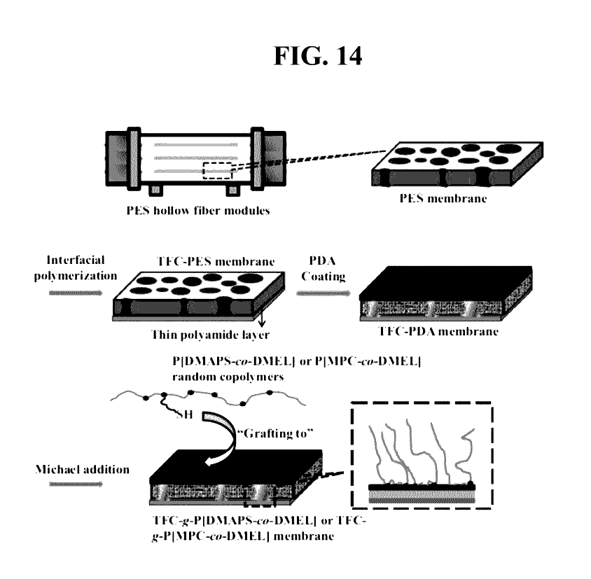

FIG. 14 illustrates the step-by-step procedure to incorporate the zwitterionic copolymers onto the poly(ethersulfone) (PES) hollow fiber membranes via the “grafting to” approach: (i) modules fabrication from PES hollow fiber membranes; (ii) deposition of an ultrathin polyamide layer on the inner surface of hollow fiber membranes via in situ interfacial polymerization; (iii) polydopamine (PDA) pretreatment of the outer surface of the membranes; (iv) tethering of zwitterionic copolymers with thiol functionalities onto the PDA pretreated PES membranes via Michael addition. To the best of the inventors' knowledge, incorporation of zwitterionic polymers onto the PDA pretreated PRO membranes has never been proposed. Examples of co-polymers which may be used include, but are not limited to 2-methacryloyloxyethyl lipoate (MEL) monomer, P[DMAPS-co-DMEL] and P[MPC-co-DMEL] random copolymers, MEL based zwitterionic copolymers. The current work may provide useful insights on the fabrication of sustainable PRO membranes with ultra low fouling characteristics for osmotic power generation.

### Example 1

### Materials and Chemicals (Embodiment 1)

Radel® A polyethersulfone (PES) was purchased from Solvay Advanced Polymer, L.L.C., USA. The solvent N-methyl-2-pyrrolidinone (NMP, >99.5%) and non-solvent polyethylene glycol (PEG or otherwise termed “PEG400”, M_{w}=400 g mol⁻¹) were ordered from Merck and Sigma-Aldrich, respectively, and were used to prepare the spinning solutions. The de-ionized water used in experiments was produced by a Milli-Q ultrapure water system (Millipore, USA). A mixture (50/50 wt %) of glycerol (Industrial grade, Aik Moh Pains & Chemicals Pte. Ltd, Singapore) and de-ionized water was prepared to post-treat as-spun hollow fiber supports before drying. m-Phenylenediamine (MPD, >99%), 1,3,5-benzenetricarbonyl trichloride (TMC, 98%), dopamine hydrochloride (99%), tris(hydroxymethyl)aminomethane (Tris, ≧99.8%), triethylamine (TEA, 99%), sodium methoxide (NaOCH₃, 95%), bis(2-hydroxyethyl)disulfide (BHEDS, 98%), glycidol (96%), 1,4-dioxane (99.8%), DL-1,4-dithiothreitol (DTT, 98%), and poly(ethylene glycol) methyl ether thiol (PEGSH, M_{w}=6000 g mol⁻¹) were bought from Sigma-Aldrich. Hexane (reagent grade) and sodium chloride (NaCl) were procured from Merck. All chemicals were used as received.

### Example 2

### Fabrication of the Hollow Fiber Membrane Support (Embodiment 1)

The hollow fiber membranes were fabricated by the co-extrusion technique using a dual layer spinneret. Prior to preparing polymer solutions, the spinning polymer, polyethersulfone (PES), was dried overnight at 90±5° C. in a vacuum oven (2 mbar) to remove moisture content. The dehydrated PES polymer was dissolved in a NMP/PEG/water mixture. After the spinning dope solution was prepared, it was degassed for several hours and then stored in a 1 L syringe pump (ISCO Inc.) overnight before spinning.

The hollow fiber supports were prepared by a dry jet wet spinning process. All nascent fibers did not experience additional extra drawing (i.e., no extension) after leaving the spinneret, which means that the take-up speed of the hollow fibers was almost the same as the falling speed into the coagulation bath. A dual-layer spinneret was employed. The spinning dope was conveyed through the middle channel, while NMP was transported via the outer channel in order to induce delayed demixing at the outer membrane surface. The outer fluid, inner dope and bore fluid were fed into the spinneret separately by three ISCO syringe pumps. After that, the dopes and the bore fluid met at the tip of the spinneret, and passed through an air gap region before entering the coagulation (water) bath. Finally, the as-spun hollow fibers were collected by a take-up drum. The detailed dope compositions and spinning conditions are summarized in TABLE 1.

TABLE 1
Spinning conditions of the hollow fiber membranes

| | |
|---|---|
| Dope solution | PES/PEG400/NMP/Water: |
| | 20.0~21.0/37.0~37.5/37.0~37.5/2.0~6.0 |
| Dope flow rate (mL/min) | 1.8 |
| Bore fluid composition (wt %) | Water |
| Bore fluid flow rate (mL/min) | 1.0 |
| Outer fluid composition (wt %) | NMP |
| Outer fluid flow rate (mL/min) | 0.1 |
| Coagulant bath composition | Tap water |
| (wt %) | |
| Take up speed (m/min) | 2.7 |
| Air gap (cm) | 1.0 |
| Spinneret dimension (mm) | Outer OD: 1.6, inner OD: 1.3, ID: 1.14 |

Legend:
PEG: polyethylene glycol;
NMP: N-methyl-2-pyrrolidinone.

After spinning, the as-spun hollow fiber membranes were rinsed in a clean water bath for 2 days to remove the residual solvent and PEG. A glycerol/water mixture (50/50 wt %) was used to soak hollow fiber supports for another two days, and then they were dried in ambient air at room temperature. Soaking membranes in the glycerol/water mixture may diminish membrane shrinkages and prevent pores from collapse during drying. Hollow fiber modules were fabricated by using Swagelok stainless fittings. For each hollow fiber sample, four modules with an outer diameter of ⅜ inch were prepared and tested to ensure good repeatability. Each module consisted of five fibers with an effective length of around 8.5 cm. A slow curing epoxy resin (EP 231, Kuo Sen, Taiwan) was used for module potting. The length of the potting portion for each end was around 1.5 cm.

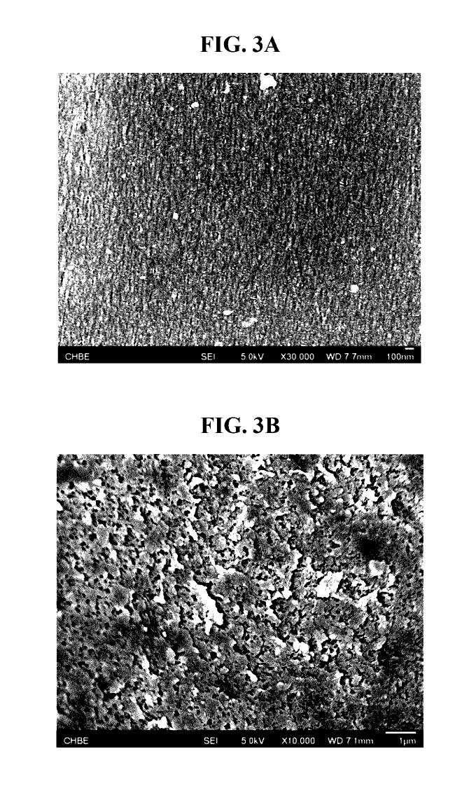

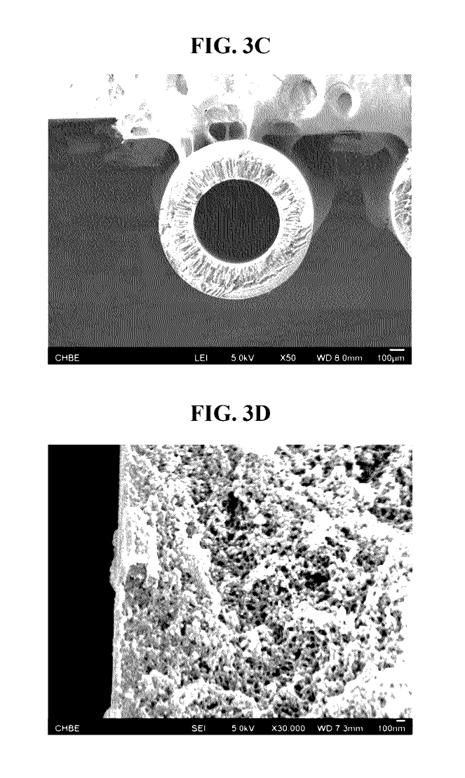

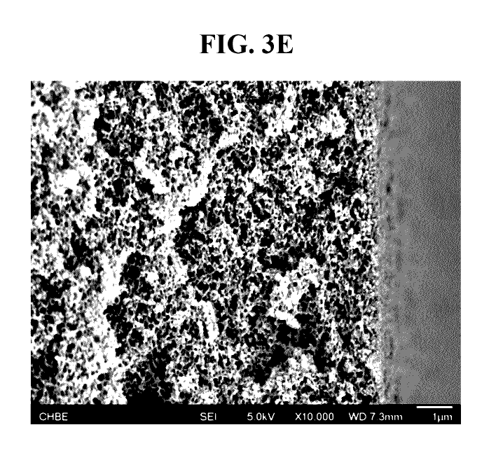

Morphologies of pristine PES hollow fiber membrane are shown in FIG. 3A to FIG. 3E. The pristine PES hollow fiber membranes were spun from dry jet wet spinning via a dual-layer spinneret. The outer diameter is around 970 μm and the inner diameter is around 560 μm.

The cross-section of the membrane is asymmetric and consists of three regions: (1) A porous outer layer; (2) A less porous inner layer; (3) A layer of finger-like macrovoids between the two sponge-like layers beneath the inner and outer membrane surfaces. The porous structure of outer surfaces may be a result of the delayed demixing induced by the outer channel solvent NMP, while the relatively dense inner structure may be ascribed to a faster demixing from the bore fluid water during the phase-inversion process. As shown in the cross-section image, a layer of finger-like macrovoids was formed between the two sponge-like layers beneath the inner and outer membrane surfaces. This structure is formed due to fast phase inversion at the lumen side and strong effects of nonsolvent (i.e., water) intrusion.

### Example 3

### Synthesis of Thiol-Terminated HPG Polymer (HPG-SH) (Embodiment 1)

HPG-SH was synthesized in 1,4-dioxane from ring-opening polymerization of glycidol, using BHEDS as the initiator and NaOCH₃ as the catalyst, followed by cleavage of the disulfide bond using excess DTT as the reducing agent.

Briefly, BHEDS (92 μl, 0.755 mmol), NaOCH₃ (4.1 mg, 0.076 mmol) and anhydrous 1,4-dioxane (10 mL) were introduced into a 50 mL single-necked round bottom flask. The solution was purged with argon for 20 min to remove the dissolved oxygen. The reaction flask was sealed under an argon atmosphere, and the reaction was allowed to proceed at 100° C. with stirring for 2 h.

Glycidol (10 mL, 151 mmol) in 1,4-dioxane (10 mL) was purged with argon for 30 min. It was added slowly with a syringe to the reaction mixture over a period of approximately 12 h. After complete addition of the solution, the reaction mixture was allowed to stir for an additional 12 h. At the end of the reaction, the reaction flask was quenched in cold water and diluted with methanol, followed by pouring into 300 mL of acetone. The adduct was purified twice by re-dissolving in methanol and re-precipitating in acetone. The HPG-S—S-HPG polymer was dried under vacuum at 80° C. to give a highly viscous liquid (yield about 74%).

The HPG-S—S-HPG (M_{n,NMR}=12,200 g mol⁻¹, 4.88 g, 0.4 mmol) polymer was dissolved in 50 mL ethanol. The reaction mixture was purged with argon for 30 min. DTT (4 mmol) was then introduced into the reaction flask. The mixture was stirred under the protection of an argon stream for 24 h at 50° C. The crude product was dialyzed against deionized water for 3 days, with the deionized water changed twice daily, using a cellulose acetate dialysis tubing (Sigma-Aldrich, MWCO 1000 g mol⁻¹). Finally, the HPG-SH polymer (M_{n,NMR}=6,100 g mol⁻¹) was isolated via lyophilization, and a pale yellow liquid was obtained (yield about 96%).

Chemical structures of the synthesized polymer were characterized by ¹H NMR spectroscopy on a Bruker ARX 300 MHz NMR spectrometer, using DMSO-d₆ as the solvent. The molecular weight and molecular weight distribution of the polymers were characterized by gel permeation chromatography (Waters GPC system) equipped with a Waters 1515 isocratic HPLC pump, a Waters 717 plus autosampler injector, a Waters 2414 refractive index detector, and a series of three linear Jordi columns. N,N-Dimethylformamide (DMF) containing 50 mM LiBr was used as the eluent at a flow rate of 1.0 ml min⁻¹. The ¹H NMR results obtained indicated that a HPG-SH polymer was successfully prepared. The HPGSH polymer used in preparing the HPG-g-PES hollow fiber membranes had a number-average molecular weight of 6100 g mol⁻¹, calculated by ¹H NMR results.

For the HPG-S—S-HPG: [M]₀/[I]₀=200:1; M_{n,NMR}=12,200 g mol⁻¹; M_{n,GPC}=15,800 g mol⁻¹, PDI=1.24. ¹H NMR (DMSO-d₆, δ, ppm, TMS): 2.5-2.7 (2H, —OCH₂CH₂S—), 3.25-3.85 (5H, —OCH—, —OCH₂—, —OCH₂CH₂S—), 4.35-4.84 (1H, —OH).

For the HPG-SH: M_{n,NMR}=6100 g mol⁻¹; M_{n,GPC}=8500 g mol⁻¹, PDI=1.22. ¹H NMR (DMSO-d₆, δ, ppm, TMS): 2.5-2.7 (2H, —OCH₂CH₂SH), 3.25-3.85 (5H, —OCH—, —OCH₂—, —OCH₂CH₂SH), 4.35-4.84 (1H, —OH).

### Example 4

### Preparation of the HPG Grafted Hollow Fiber Membrane Supports Embodiment 1

Prior to polymer grafting, polydopamine-coated hollow fiber membrane supports (PDA-PES) were prepared. 200 mg dopamine-HCl in a 1 L Tris buffer solution (0.01 mol L⁻¹, pH 8.5) was used to coat hollow fiber supports for 3 h. After polydopamine (PDA) coating, HPG-grafted hollow fiber supports were prepared by Michael addition between polydopamine and HPG-SH. PES hollow fiber supports were soaked in a 10 g HPG-SH water solution containing triethylamine (TEA) of 0.7%, v/v at room temperature. The amount of HPG was excessive and the reaction time was 12 h to ensure the completion of the coating. Reference experiments were conducted by using a commercial chemical, PEG-SH (M_{w}=6,000 g mol⁻¹), to replace HPG-SH at the same conditions to represent the linear antifouling agent on the PDA-PES supports.

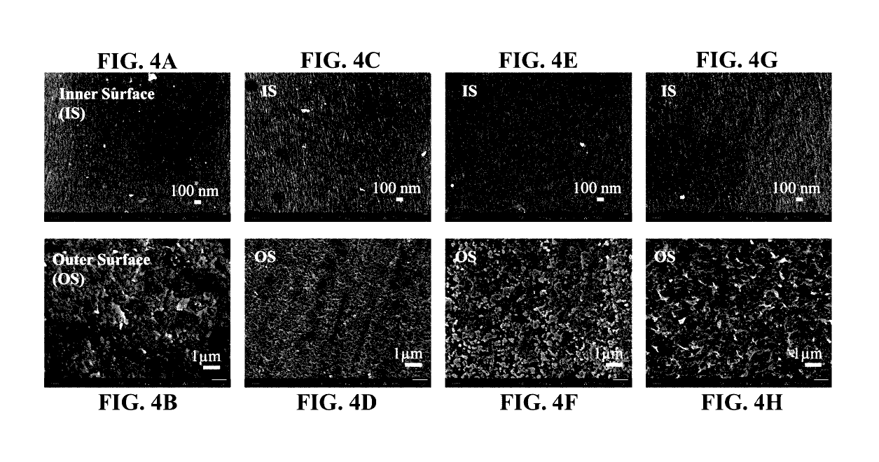

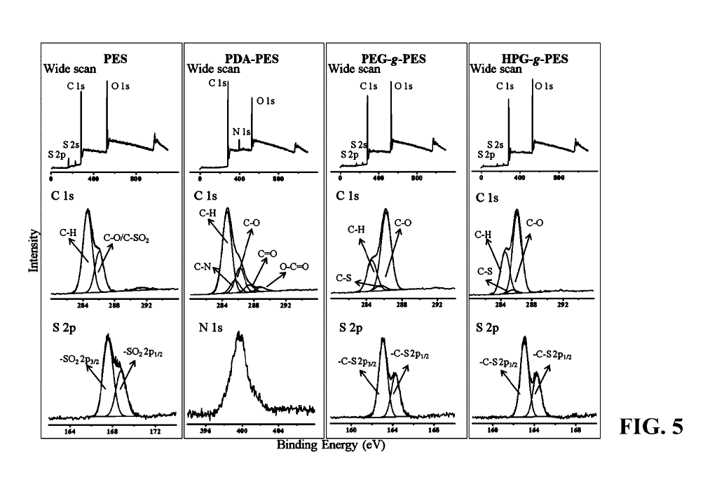

FIG. 4A to 4H are scanning electron microscopy (SEM) images of inner surface and outer surface of hollow fiber supports of pristine PES, PDA-PES, PEG-g-PES, and HPG-g-PES. All supports show similar surface morphologies of both inner and outer surfaces, indicating the PDA modification and grafting have no visible effects on the membrane structure.

FIG. 5 shows X-ray photoelectron spectroscopy (XPS) wide scan, C 1s, S 2p, and N 1s core-level spectra of four hollow fiber membrane supports of PES, PDA-PES, PEG-g-PES, and HPG-g-PES.

In the case of the pristine PES support, C 1s, O 1s, S 2s, and S 2p signals are observed in the wide-scan spectrum. The C 1s core-level can be curve-fitted into two peaks with binding energies at about 284.6 eV and 286.1 eV, attributable to the C—H and C—O/C—SO₂ species, respectively. The S 2p signal can be curve-fitted into peaks at 167.6 eV for the —SO₂ 2p_{3/2} species and 168.8 eV for the —SO₂ 2p_{1/2} species which belong to the strong spin-orbit split doublet of the sulfone group in PES molecules. After PDA treatments, S signals of PDA-PES membranes in the XPS wide scan spectrum disappear and the N 1s signal appears, confirming the successful covering of a PDA layer onto the PES support. The C 1 s core level spectrum combines the C—N, C—H, C—O, C═O, and O—C═O species, which are components of polydopamine molecules.

For HPG-g-PES membranes, the presence of HPG grafting is ascertained by the XPS wide scan, C 1 s and S 2p spectra. The appearance of S 2s and S 2p signals in the wide scan is consistent with the sulfur site of the HPG polymer. The S 2p core-level spectrum consisting of the —C-S2p_{3/2} species and —C-S2p_{1/2} species also shows the covalent bonding of grafted HPG segments. Similar XPS results may be found for the PEG-g-PES membranes as they share similar chemical bonding and grafting on the membrane surfaces with HPG-g-PES membranes.

### Example 5

### Anti-Fouling Assays (Embodiment 1)

In order to study the anti-fouling performance of the modified membranes, several assays were conducted. The resistance against protein adsorption is an important indication of the antifouling performance of membranes. Fluorescence microscopy of fluorescein-labeled bovine serum albumin (BSA) was chosen to sensitively and reliably measure protein adsorption onto membranes.

Adsorption of fluorescein isothiocynate conjugated bovine serum albumin (BSA-FITC) on the pristine PES membrane supports, PDA-modified supports, PEG-g-PES supports, and HPG-g-PES supports was examined with a fluorescence microscope. The membrane supports were rinsed initially with a phosphate buffered saline (PBS) solution and then soaked in the BSA-FITC solution (0.5 mg mL⁻¹ PBS solution) at room temperature for 1 h. The adsorption was imaged with a Leica DMLM fluorescence microscope (Leica Microsystems, Wetzlar, Germany), equipped with an excitation filter of 495 nm and an emission filter of 525 nm. The fluorescence intensity, which was proportional to the surface density of the adsorbed BSA-FITC protein, was quantified using ImageJ software (National Institutes of Health, Bethesda, Md., U.S.A.).

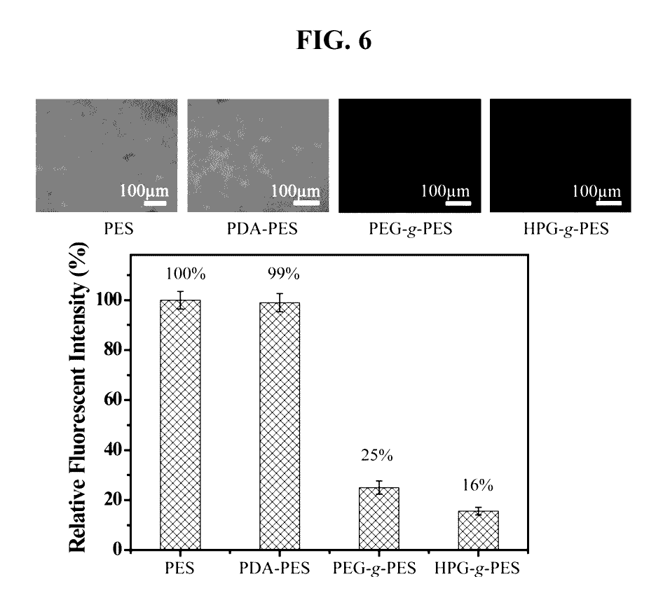

FIG. 6 displays the relative fluorescence intensities and fluorescence microscopy images of the pristine PES membrane surface and polymer functionalized membrane surfaces of PDA-PES, PEG-g-PES, and HPG-g-PES after exposure to a 0.5 mg mL⁻¹ PBS solution of fluorescein isothiocynate-conjugated BSA (BSA-FITC). The pristine PES surface is covered with a large concentration of BSA molecules due to the hydrophobic-hydrophobic interactions between conjugated benzene rings of PES and protein molecules. The adsorption of BSA is slightly reduced on the PDA-PES membrane surface because of the repulsive forces arising from the hydrophilic PDA surface. However, the benzene rings and possible π-π stacking structure of PDA may attract proteins. Therefore, the fluorescence on the PDA-PES surface is also uniform and intense. The BSA adsorption significantly decreases on the PEG-g-PES surface. The fluorescence intensity is more than 70% lower than that on the pristine PES surface. The enhanced antiadsorption effect is attributed to the strong repulsive force between —OH groups of PEG and proteins. The dendritic structure of HPG achieves better anti-adsorption behavior than the linear PEG. After HPG grafting, the fluorescence is barely visible on the HPG-g-PES surface. The fluorescence intensity is only 16% of that on the pristine PES surface. The commercial PEG shows an intensity of 25% in comparison.

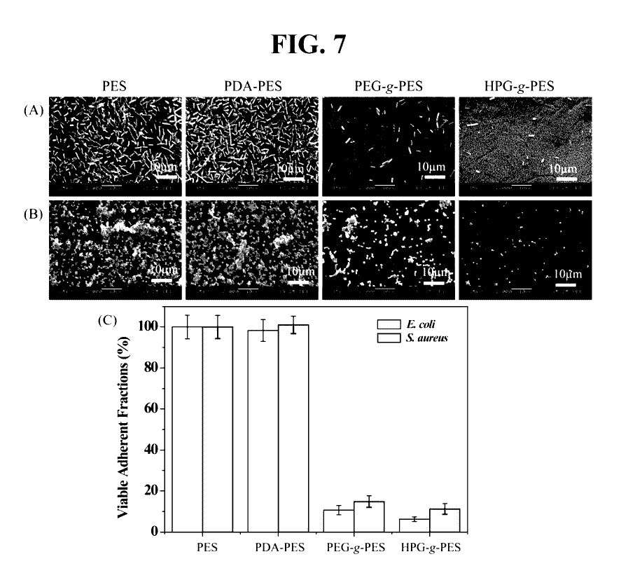

Bacterial fouling on the pristine and polymer-functionalized membrane surfaces has been investigated. SEM images of the bacterial adhesion were taken after the hollow fiber membranes have been exposed to E. coli or S. aureus bacteria for 4 h (FIG. 7A,B). Gram-negative Escherichia coli (E. coli, ATCC DH5α) and Gram-positive Staphylococcus aureus (S. aureus, ATCC 25923) or Gram-positive S. epidermidis (ATCC 35984) were used for the evaluation of the antibacterial adhesion characteristics and bactericidal efficacy of the hollow fiber membranes.

E. coli and S. aureus were cultured in the nutrient broth and tryptic soy broth, respectively, at 37° C. overnight. Overnight bacterial culture broths were centrifuged at 2700 rpm for 10 min to remove the supernatant. The bacteria were washed with PBS twice and resuspended in PBS (pH 7.4) at a concentration of 5×10⁷ cells mL⁻¹. The bacterial concentrations were estimated from the optical density of the suspension based on a standard calibration from spread plate counting.

Quantification of bacteria adhesion and viability on membrane supports were carried out by the spread plate method. Briefly, after washing with PBS as described above, the substrates were put into 2 mL of PBS and subjected to ultrasonication for 7 min, followed by vortexing for 20 s to release the cells. The bacterial solution was then serially diluted, spread on the agar plate, and cultured overnight to quantify the number of bacterial cells. All experiments were performed in triplicate with three samples, and the mean values were calculated. The results were expressed as viable adherent fractions, defined as percentages of viable adherent bacteria cells on the modified membrane surface relative to those on the pristine PES surface.

An optical density of 0.1 at 540 nm was equivalent to 10⁸ cells mL⁻¹. Each membrane was then immersed in the bacterial suspension at 37° C. for 4 h. After fixing with 3% glutaraldehyde and dehydrating with serial ethanol, adhered bacterial cells were investigated under SEM.

The morphology of membranes was examined by a scanning electronic microscope (SEM JEOL JSM-5600LV) and a field emission scanning electronic microscope (FESEM, JEOL JSM-6700F). Before SEM/FESEM tests, samples were prepared in liquid nitrogen followed by platinum coating using a JEOL JFC-1100E ion sputtering device. X-ray photoelectron spectroscopy (XPS) was used to measure the chemical composition of the functionalized membranes. XPS measurements were conducted on a Kratos AXIS Ultra HSA spectrometer equipped with a monochromatized Al Kα X-ray source (1468.6 eV photons). Elemental stoichiometries of the membrane surface were determined from peak-area ratios with the reliability of ±5%.

The SEM images (FIG. 7A,B) show that the pristine PES membrane and the PDA-PES membrane were seriously fouled with both E. coli and S. aureus bacteria. A large amount of bacterial cells adhered readily to the membrane surfaces, and stacks in clusters. In comparison, the attachment on HPG-g-PES membrane exhibited small amounts of bacterial cells, suggesting a significant anti-bacterial adhesion effect of HPG grafting. The PEG-g-PES membrane was also not highly susceptible to adhesion and colonization of bacteria. However, many small bacterial clusters were still observed on the PEG-g-PES surface.

To further investigate the antimicrobial properties of the hollow fiber membranes, a quantitative antifouling assay was conducted by using the spread plate method. FIG. 7C depicts the viable adherent fractions of E. coli and S. aureus bacteria after exposure to the pristine and modified membranes for 4 h.

The amount of E. coli adhesion decreases monotonically after polymer modifications, with a viable adherent fraction of 98.2% for the PDA-PES, 10.7% for the PEG-g-PES, and 6.3% for the HPG-g-PES, respectively compared to that of the pristine PES membrane. On the other hand, after S. aureus exposure, the PDA-modified membrane shows a similar quantitative adhesion (101.0%), in comparison to the pristine PES membrane, while the HPG-g-PES and PEG-g-PES membranes reduce the adhesion to 11.3% and 14.9%, respectively, in comparison to the pristine PES membrane. The HPG-g-PES membranes became much more hydrophilic after modification.

These hydrophilic polymer brushes can form highly hydrated ultrathin coatings that provide an effective enthalpic and entropic barrier to non-specific bacteria adsorption and impart the membrane surface with improved antifouling property. It has been predicted theoretically that, at an equivalent area per molecules, a branched polymer will be more efficient in protein/bacteria rejection than its linear counterpart.

In summary, in embodiments disclosed herein, the bacterial adhesion has been shown to be essentially inhibited by the grafting of hyperbranched polyglycerol, and the antibacterial performance of surface-grafted HPG membranes has been shown to be higher than that of membranes with conventional linear PEG of a similar molecular weight.

From a safety perspective, the saline stream pair (e.g. seawater and river water) used in PRO processes does not allow passage through a toxic membrane surface. Therefore, the cytotoxicity of the newly modified membranes was evaluated by the in vitro experiments of the MTT (3-(4,5-dimethylthiazol-2-yl)-2,5-diphenyltetrazolium bromide) cell-viability assay.

The cytotoxicity of membranes was evaluated by determining the viability of mouse 3T3 fibroblasts after incubation in the medium containing the membranes. The membranes were sterilized with 75% ethanol and recovered after drying under a reduced pressure before use. Control experiments were carried out using the growth culture medium without membranes. Cell viability testing was carried out via the reduction of the MTT reagent (3-(4,5-dimethylthiazol-2-yl)-2,5-diphenyltetrazolium bromide). The 3T3 fibroblasts were first seeded in a 24-well culture plate and incubated at 37° C. for 24 h, and then the medium was replaced with a fresh medium containing different membranes of 1 cm length. The 3T3 fibroblasts were incubated at 37° C. for another 24 h in the medium. After that, the culture medium in each well was removed. Ninety milliliters of medium and 10 mL of MTT solutions (5 g L⁻¹ in PBS) were mixed and distributed to each well. The volume of each well in the 24 well plate is about 1 mL. After 4 h of incubation at 37° C., the medium was removed, and the formazan crystals (a purple-color dye from reduction of MTT in living cells) were solubilized with 100 mL of dimethyl sulfoxide (DMSO) for 15 min. The optical absorbance was measured at 560 nm on a microplate reader (Tecan GENios). The results were expressed as percentages relative to that obtained in the control experiment.

FIG. 8 shows the results that both the HPG-g-PES and PEG-g-PES membranes exceed 96% for the viability of 3T3 fibroblasts cells in comparison of the control experiment, indicating that the introduction of HPG branches onto the PES membrane surface has negligible cytotoxicity effect to viable cells. Meanwhile, the viability of cells on the PDA-PES membrane surface was slightly lower (92%), which may be due to the toxicity of imine groups of the PDA structure.

### Example 6

### Fabrication of TFC Membranes (Embodiment 1)

The TFC polyamide membrane was synthesized on the inner surface of the respective pristine and polymer grafted hollow fiber supports mentioned above by interfacial polymerization using the following procedures: (1) the membrane module was held vertically and purged by compressed air to sweep impurities on the inner surface of hollow fibers; (2) a MPD solution of 1.1 wt % was introduced to the inner surface of hollow fiber supports vertically from bottom to top at a flow rate of 2.2 ml min⁻¹ for 3 min; (3) the excess MPD aqueous solution was removed by purging with compressed air for 3 min; (4) a hexane solution containing 0.2 wt % TMC was fed to the inner face of the fibers with a flow rate of 2.2 ml min⁻¹ for 3 min followed by a 15-min heat treatment in an oven at 65° C. Finally, the resultant TFC membrane was washed thoroughly with de-ionized water and stored in de-ionized water before tests.

### Example 7

### PRO Performance and Membrane Fouling Tests in PRO Processes Embodiment 1

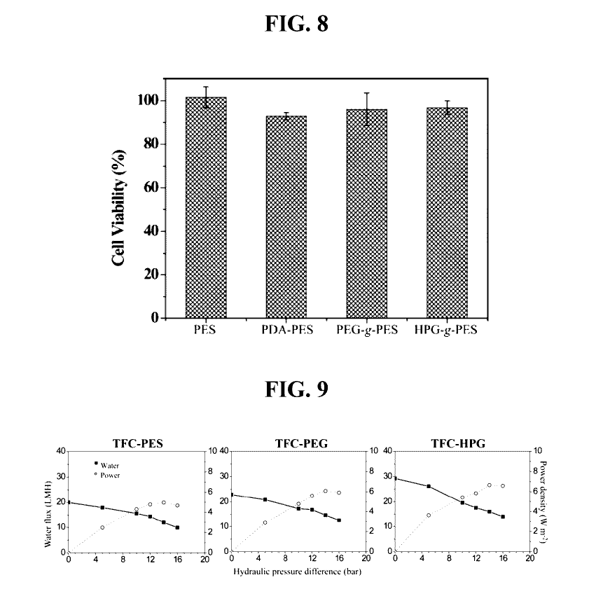

FIG. 9 shows the membrane performance of TFC-PES, TFC-PEG, and TFC-HPG in high pressure PRO tests in terms of water flux and power density as a function of pressure. The power density was calculated by Equation (1):

W=J_{w}ΔP (1)

where ΔP is the hydraulic pressure difference across the membrane and J_{w} is the water permeation flux.

Synthetic seawater (3.5% NaCl in water) and de-ionized water were used as draw and feed solutions, respectively. The PRO tests were conducted in a safe pressure range (0-16 bar) to avoid the “bursting” phenomenon where the water flux reversely flows across the membrane from the draw solution into the fresh water.

As shown in FIG. 9, the TFC-HPG membrane possesses an enhanced initial water flux at 0 bar than the TFC-PES and TFC-PEG membranes. This is because of the higher wettability of the HPG grafted membrane surface. All TFC membranes demonstrate a water flux decline with increasing ΔP because of the reduction in effective driving force. The TFC-PES membrane exhibits a maximum power density of 5.0 W m⁻², while the TFC-PEG membrane fabricated from the PEG-g-PES support shows an improved maximum power density of 6.0 W m⁻². In contrast, the TFC-HPG membrane further increases the maximum power density to 6.7 W m⁻² due to the higher water flux induced by HPG grafting. Clearly, the HPG functionalized membranes produce a better PRO performance.

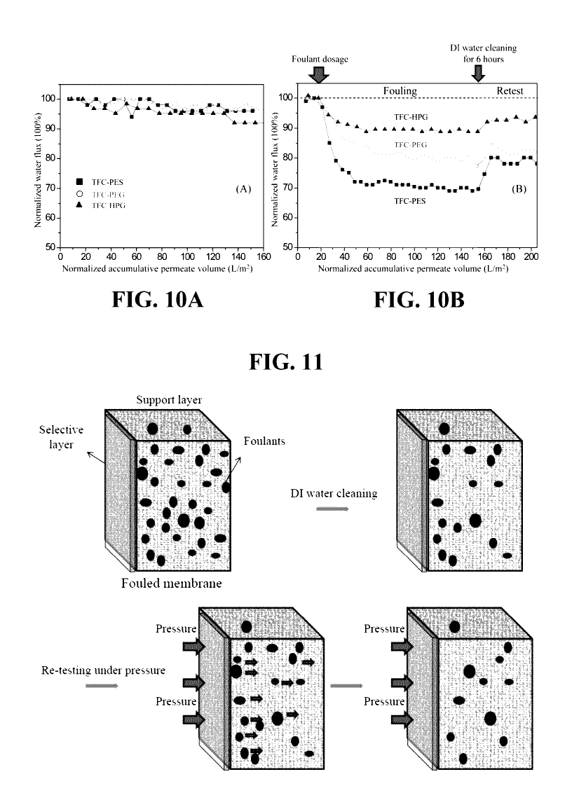

Prior to the fouling experiments, baseline experiments were performed to quantify the flux decline due to the dilution of draw solution, concentration of feed solution, and the resultant decrease in osmotic pressure difference. As shown in FIG. 10A, the baseline experiments were conducted at an identical effective hydraulic pressure difference of 12.5±1 bar for the TFC-PES, TFC-PEG, and TFC-HPG membranes. The normalized water flux is plotted against the normalized accumulative permeate volume (i.e., normalizing it to the same membrane surface area). The baseline curves of TFC-PES (rectangles) and TFC-PEG (circles) membranes have similar trends as their initial water fluxes are comparable, and the final water fluxes are about 96% of the initial ones. The TFC-HPG membrane exhibits the most serious dilution effect as shown by the triangles because it has the highest initial water flux among three membranes. Its final water flux is 92% of the initial value.

The PRO fouling tests were conducted on a lab-scale PRO set-up. TFC membranes were oriented in the PRO mode (i.e., selective layer faces the draw solution) for all tests.

To study the fouling in PRO processes, BSA was chosen to dose the feed solution and model the protein foulants during PRO tests. Before the foulant dosage, fresh TFC hollow fiber membranes were conditioned at 12.5±1 bar for 1 h. To initiate the fouling test, 200 mg L⁻¹ bovine serum albumin (BSA) was dosed into the feed solution. The experiments were conducted in the same conditions as in the baseline experiments in the presence of foulants.

A variable-speed gear pump (Cole-Palmer, Vernon Hills, Ill.) was utilized to recirculate the feed solution through the shell side of the hollow fibers, and a high-pressure hydra cell pump was employed to recirculate the draw solution through the lumen side. After fouling tests and before the next PRO test, membrane cleaning by deionized water was performed on both sides of the membrane, where countercurrent flows of deionized water at a flow rate of 0.1 L min⁻¹ were applied to both the lumen and the shell sides of hollow fiber membranes without pressure for 6 h (24±1° C.).

FIG. 10B demonstrates the fouling and recovering behaviors of the TFC membranes. The rectangular symbols indicate the normalized water flux of the TFC-PES membrane during the fouling test as a function of normalized cumulative permeate volume.

Immediately after the foulant dosage, the water flux substantially declines over the first 20 to 40 L m⁻² of the normalized permeate volume, then the water flux drops slowly and gradually to less than 70% of the initial flux at the end of the fouling test when the normalized permeate volume is about 150 L m⁻². The significant flux drop is consistent with the fouling assay of the PES membrane support, attributable to the fouling susceptible nature of PES and resultant adhesion of foulants onto the porous membrane support.

After fouling tests and before the next PRO test, membrane cleaning was performed. Counter-current flows of de-ionized water at a flow rate of 0.1 L min⁻¹ were applied to both the lumen and the shell sides of hollow fiber membranes without pressure for 6 h (24±1° C.).

The cleaned membranes were retested under PRO tests at 12.5±1 bar. A sudden flux increase to 80% of the initial value is observed for the fouled and recleaned TFC-PES membrane. This phenomenon may be due to the “back pulse” effect from the hydraulic pressure in the draw solution side, such as that illustrated in FIG. 11. Since foulants have accumulated within the porous support and beneath the dense layer during the fouling test, some may be washed away during the cleaning, while some remain. In the subsequent high-pressure PRO test, the pressurized draw solution suddenly impulses the dense layer from the lumen side, expands and stretches the hollow fiber radially outward, and loosens the foulants adhered or trapped within the membrane. Therefore, the water flux goes up to some extent.

Similar trends may be observed for both PEG and HPG membranes. In the case of the PEG membrane (round circle dots), a steep water flux decrease was found in the early stage of the fouling test. Then the fouling progressively deteriorated the membrane performance, with a normalized flux dropping by about 23% at the end of the fouling test. The water flux of the TFC-PEG membrane may eventually be recovered to about 84% at the subsequent PRO test, suggesting an antifouling effect of the surface-grafted TFC-PEG membrane.

For the TFC-HPG membrane, the antifouling effect of HPG branches was more evident. The water flux attrition significantly eased off in the fouling test. The reduction in water flux due to fouling was only about 11%. After cleaning and hydraulic pressure impulsion, the eventual flux decline was about 6%, which was impressively low.

Clearly, from the results demonstrated herein, the hyperbranched polyglycerol grafting onto the hollow fiber membrane support achieves a good antifouling performance. It is worthwhile to note once again that the antifouling effects of the HPG membrane are much better than its linear representative PEG membrane.

In this work, the inventors have successfully designed antifouling PRO membranes by synthesizing hyperbranched polyglycerols (HPG) with one thiol site (HPG-SH) from ring-opening polymerization of glycidol and grafting them onto the poly(ether sulfone) (PES) hollow fiber membranes. Assays of SEM, XPS, fluorescence microscopy, and spread plate method have verified that the introduction of hydrophilic HPG branches to PES membrane surfaces imparts good antiprotein adsorption and antibacterial adhesion properties without changing the morphology and bulk properties of the hollow fiber membranes. Cytotoxicity experiments further confirm the nontoxic nature of the HPG grafting. In high pressure PRO tests, the HPG-grafted TFC membrane achieves higher performance in terms of water flux and power density in comparison of the pristine TFC and PEG grafted TFC membranes. Furthermore, the protein fouling on the HPG grafted TFC membrane has been largely alleviated. After cleaning, the recovered flux in PRO tests is as high as about 94% of the initial value from a fresh TFC-HPG membrane. The present approach provides an effective means for the molecular design of antifouling PRO membranes.

### Example 8

### P[DMAPS-co-DMEL] and P[MPC-co-DMEL] Random Copolymers (Embodiment 2)

Reversible addition-fragmentation chain transfer (RAFT) polymerization is a powerful strategy for generating polymers with various macromolecular constructions, controlled molecular weight, narrow polydispersity and well-preserved end group functionality under mild reaction conditions in the absence of metal catalysts. As presently disclosed, narrowly dispersed random copolymers were prepared by RAFT polymerization between the zwitterionic monomer of [2-(methacryloyloxy)ethyl]dimethyl-(3-sulfopropyl) ammonium hydroxide (DMAPS) and the disulfide-containing monomer of 2-methacryloyloxyethyl lipoate (MEL) in the presence of 4-cyano-4-(phenylcarbonothioylthio)pentanoicacid (CTP) as the RAFT agent and 2,2′-azobis(2-methylpropionitrile) (AIBN) as the initiator, followed by reduction of the disulfide groups to give dihydrolipoic acid pendent groups (PDMEL), as shown in FIG. 12A.

FIG. 12A shows synthesis route for P[DMAPS-co-DMEL] random copolymer according to an embodiment.

For comparison purposes, zwitterionic copolymers of 2-methacryloyloxyethylphosphorylcholine (MPC) and MEL (P[MPC-co-MEL] copolymers) with comparable molecular weights have been synthesized using reaction conditions similar to those used for the preparation of P[DMAPS-co-MEL] copolymers.

Reductive scission of the disulfide bonds in PMEL component was conducted using excess NaBH₄.

FIG. 12B shows synthesis route for P[MPC-co-DMEL] random copolymer according to an embodiment.

### Example 9

### Materials (Embodiment 2)

Dimethyl sulfoxide (DMSO, ≧99%), (±)-α-lipoic acid (LA, ≧99%), 2-hydroxyethyl methacrylate (HEMA, 97%), 4-(N,N-dimethylamino)pyridine (DMAP, ≧99%), dicyclohexylcarbodiimide (DCC, 98%), 4-cyano-4-(phenylcarbonothioylthio)pentanoic acid (CTP, >97%), [2-(methacryloyloxy)ethyl]dimethyl-(3-sulfopropyl)ammonium hydroxide (DMAP, 97%), 2-methacryloyloxyethyl phosphorylcholine (MPC, 97%), 4,4′-azobis(4-cyanopentanoic acid) (ACVA, ≧98%), sodium borohydride (NaBH₄, 98%), trimesoyl chloride (TMC, 98%) and m-phenylenediamine (MPD, >99%) were obtained from Sigma-Aldrich Chem. Co. and used as received without further purification. The radical initiator, 2,2′-azobis(2-methylpropionitrile) (AIBN, 97%) was purchased from Kanto Chemical Co. (Tokyo, Japan) and was recrystallized from anhydrous ethanol. Dichloromethane (DCM, reagent grade) and diethyl ether (reagent grade) were purchased from Merck Chem. Co. and used as received without further purification. Gram-positive Staphylococcus epidermidis (S. epidermidis ATCC35984) and Gram-negative Escherichia coli (E. coli, ATCCDH5α) were obtained from American Type Culture Collection, Manassas, Va., USA.

### Example 10

### Synthesis of the 2-Methacryloyloxyethyl Lipoate (MEL) Monomers (Embodiment 2)

The MEL monomer was prepared according to the method below. LA (9.9 g, 48 mmol), DCC (9.9 g, 48 mmol), DMAPS (1.17 g, 9.6 mmol) and anhydrous dichloromethane (170 mL) were introduced into a 500 mL single-necked round bottom flask. The flask was immersed in an ice bath, and HEMA (5.9 mL, 48 mmol) in dry dichloromethane (30 mL) was added dropwise. Upon completion of the addition, the reaction mixture was kept in the ice-water bath for 1 h and then at room temperature for 24 h. The precipitated 1,3-dicyclohexylurea (DCU) was filtered off and the solvent was evaporated. The crude product was purified by column chromatography using hexane: dichloromethane (10:1, v/v). The MEL monomer was obtained as yellow oil (yield about 95%).

IR (cm⁻¹): 1735 (C═O). ¹H NMR (CDCl₃, δ, ppm, TMS): 1.47 (2H, —CH₂CH₂CH₂—), 1.67 (4H, —CH₂CHSS—, —CH₂CH₂C(═O)O—), 1.91 (1H, —CH₂CH₂SS—), 1.94 (3H, —CH₂═C(CH₃)—), 2.35 (2H, —CH₂C(═O)O—), 2.46 (1H, —CH₂CH₂SS—), 3.12 (2H, —CH₂SS—), 3.55 (1H, —CHSS—), 4.33 (4H, —C(═O)OCH₂—), 5.59 (1H, —CH₂═C(CH₃)—), 6.12 (1H, —CH₂—C(CH₃)—).

### Example 11

### Synthesis of the P[MPC-co-MEL] Random Copolymers Embodiment 2

The P[MPC-co-MEL] random copolymers were prepared via reversible addition-fragmentation chain-transfer (RAFT) polymerization between MPC and MEL monomers using ACVA as the initiator and CTP as the RAFT agent. In a typical reaction, MPC (2.5 g, 8.47 mmol), MEL (135 mg, 0.42 mmol), ACVA (4.7 mg, 0.017 mmol), CTP (23.7 mg, 0.085 mmol), deionized water (10 mL) and DMSO (10 mL) were introduced into a 50 mL reaction flask. The light red homogeneous solution was purged with argon for about 20 min to remove the dissolved oxygen. The reaction flask was then sealed and placed in an oil bath at 70° C. to initiate the polymerization. At the end of the reaction (24 h), the reaction flask was quenched in cold water. The reaction mixture was diluted with deionized water and then dialyzed against deionized water for 3 days, with the deionized water changed twice daily, using a cellulose acetate dialysis tubing (Sigma-Aldrich, MWCO 2000 g/mol). Finally, the polymer was isolated via lyophilization and obtained as a pink solid (yield about 85%).

IR (cm⁻¹): 1735 (C═O). ¹H NMR (D₂O, δ, ppm, TMS): 0.75-1.1 (3H×(x+y), —CH₂C(CH₃)—), 1.45-1.57 (2H×x, —CH₂CH₂CH₂—), 1.7-2.1 (2H×x+7H×y, —CH₂C(CH₃)—, —CH₂CHSS—, —CH₂CH₂C(═O)O—, —CH₂CH₂SS—), 2.45-2.6 (3H×y, —CH₂C(═O)O—, —CH₂CH₂SS—), 3.05-3.2 (9H×x+2H×y, —N⁺(CH₃)₃, —CH₂SS—), 3.55-3.7 (2H×x+1H×y, —CH₂N⁺(CH₃)₃, —CHSS—), 3.95-4.3 (6H×x+4H×y, —CH₂OPO₃⁻CH₂—, —C(═O)OCH₂—). As can be seen from FIG. 12B, x and y denote the degree of polymerization of MPC and MEL monomers in the P[MPC-co-MEL] random copolymers, respectively.

### Example 12

### Synthesis of the P[MPC-co-DMEL] Random Copolymers Embodiment 2

Briefly, P[MPC-co-MEL] (1.0 g) and deionized water (20 mL) were introduced into a 50 mL reaction flask. The polymer solution was cooled to 0° C. NaBH₄ (37.5 mg, 1 mmol) was then added to the reaction mixture. The reaction was stirred at 0° C. until the pink solution became light yellow (around 2 h). The reaction mixture was quenched with 1 mol/L HCl and the pH was adjusted to 3 (measured by the pH paper) to ensure the total completion of NaBH₄. The reaction mixture was diluted with deionized water and then dialyzed against deionized water for 3 days, with the deionized water changed twice daily, using a cellulose acetate dialysis tubing (Sigma-Aldrich, MWCO 2000 g/mol). Finally, the polymer was isolated via lyophilization and obtained as a white solid (yield about 95%).

IR (cm⁻¹): 1735 (C═O), 2560 (—SH). ¹H NMR (D₂O, δ, ppm, TMS): 0.75-1.1 (3H×(x+y), —CH₂C(CH₃)—), 1.1-1.15 (3H×y, —CHSH, —CH₂SH), 1.45-1.57 (2H×x, —CH₂CH₂CH₂—), 1.7-2.1 (2H×x+8H×y, —CH₂C(CH₃)—, —CH₂CH₂C(═O)O—, —CH₂CHSH, —CH₂CH₂SH), 2.4-2.5 (2H×y, —CH₂C(═O)O—), 2.52-2.65 (2H×y, —CH₂SH), 2.85-2.95 (1H×y, —CHSH), 3.05-3.2 (9H×x, —N⁺(CH₃)₃), 3.55-3.7 (2H×x, —CH₂N⁺(CH₃)₃), 3.95-4.3 (6H×x+4H×y, —CH₂OPO₃⁻CH₂—, —C(═O)OCH₂—).

### Example 13

### Synthesis of the P[DMAPS-co-MEL] Random Copolymers Embodiment 2

The P[DMAPS-co-MEL] random copolymers were prepared via reversible addition-fragmentation chain-transfer (RAFT) polymerization of the DMAPS and MELmonomers using AIBN as the initiator and CTP as the RAFT agent. In a typical reaction, DMAPS (10.0 g, 35.8 mmol), MEL (0.57 g, 1.79 mmol), AIBN (11.8 mg, 0.072 mmol), CTP (100 mg, 0.358 mmol) and DMSO (120 mL) were introduced into a 250 mL reaction flask. The light red homogeneous solution was purged with argon for about 20 min to remove the dissolved oxygen. The reaction flask was then sealed and placed in an oil bath at 70° C. to initiate the polymerization. At the end of the reaction (24 h), the reaction flask was quenched in cold water, followed by precipitating into a large volume (600 mL) of diethylether. The crude product was redissolved in deionized water and then dialyzed against deionized water for 3 days, with the deionized water changed twice daily, using a cellulose acetate dialysis tubing (Sigma-Aldrich, MWCO2000 g/mol). At least ten experiments with a yield of 75-85% have been performed to ensure the reproducibility of synthesis. Finally, the polymer was isolated via lyophilization and obtained as a pink solid.

IR (cm⁻¹): 1735 (C═O). ¹H NMR (D₂O, δ, ppm, TMS): 0.85-1.2 (3H×(m+n), —CH₂C(CH₃)—), 1.52-1.65 (2H×n, —CH₂CH₂CH₂—), 1.7-2.1 (2H×m+7H×n, —CH₂C(CH₃)—, —CH₂CH₂C(═O)O—, —CH₂CHSS—, —CH₂CH₂SS—), 2.1-2.3 (2H×n, —CH₂CH₂SO₃⁻), 2.45-2.55 (2H×m+1H×n, —CH₂C(═O)O—, —CH₂CH₂SS—), 2.9-3.05 (2H×m, —CH2SO₃⁻), 3.1-3.35 (2H×m+2H×n, —CH₂N⁺(CH₃)₂—, —CH₂SS—), 3.5-3.7 (2H×m+1H×n, —N⁺(CH₃)₂CH₂—, —CH₂CHSS—), 3.7-3.85 (2H×m, —CH₂N⁺(CH₃)₂—), 4.35-4.6 (2H×m+4H×n, —C(═O)OCH₂—). As can be seen from FIG. 12A, m and n denote the degree of polymerization of DMAPS and MEL monomers in the P[DMAPS-co-MEL] random copolymers, respectively.

### Example 14

### Synthesis of the P[DMAPS-co-DMEL] Random Copolymers Embodiment 2

Briefly, P[DMAPS-co-MEL] (1.0 g), NaCl (100 mg) and deionized water (20 mL) were introduced into a 50 mL reaction flask. The polymer solution was cooled to 0° C. NaBH₄ (37.5 mg, 1 mmol) was then added to the reaction mixture. The reaction was stirred at 0° C. until the pink solution became light yellow (around 2 h). The reaction mixture was quenched with 1 mol/L HCl and the pH was adjusted to 3 (measured by the pH paper) to ensure the total completion of NaBH₄. The reaction mixture was diluted with deionized water and then dialyzed against deionized water for 3 days, with the deionized water changed twice daily, using a cellulose acetate dialysis tubing (Sigma-Aldrich, MWCO 2000 g/mol). Finally, the polymer was isolated via lyophilization and obtained as a white solid (yield about 97%).

IR (cm⁻¹): 1735 (C═O), 2560 (—SH). ¹H NMR (D₂O, δ, ppm, TMS): 0.85-1.2 (3H×m+5H×n, —CH₂C(CH₃)—, —CH₂SH, —CHSH), 1.52-1.65 (2H×n, —CH₂CH₂CH₂—), 1.7-2.1 (2H×m+8H×n, —CH₂C(CH₃)—, —CH₂CH₂C(═O)O—, —CH₂CHSH, —CH₂CH₂SH), 2.1-2.3 (2H×n, —CH₂CH₂SO₃⁻), 2.35-2.5 (2H×n, —CH₂C(═O)O—), 2.52-2.62 (2H×n, —CH₂SH), 2.9-3.05 (2H×m+1H×n, —CH₂SO₃⁻, —CHSH), 3.1-3.35 (2H×m, —CH₂N⁺(CH₃)₂—), 3.5-3.7 (2H×m, —N⁺(CH₃)₂CH₂—), 3.7-3.85 (2H×m, —CH₂N⁺(CH₃)₂—), 4.35-4.6 (2H×m+4H×n, —C(═O)OCH₂—).

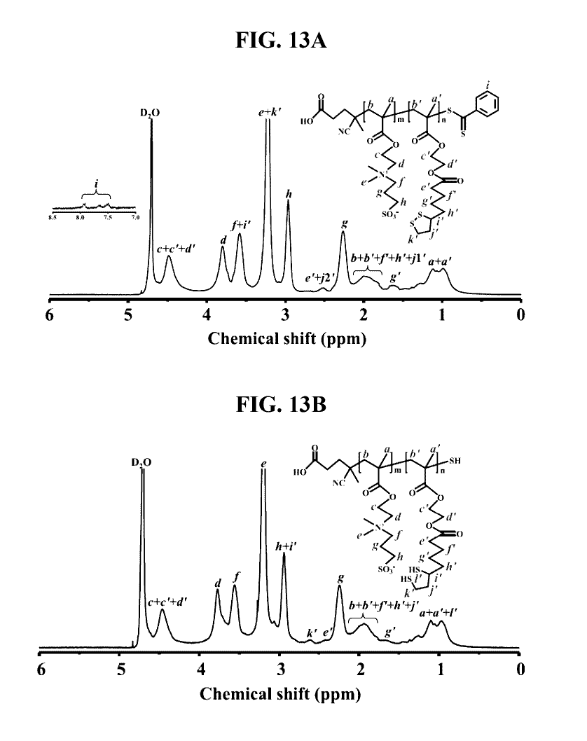

Since the disulfide group of MEL can participate in metal chelation, atom transfer radical polymerization (ATRP) is not suitable for the present study. The molar feed ratio of DMAPS to CTP was set at 100. With the increase in molar feed ratio of [MEL]/[CTP] from 5 to 15, the number average molecular weight (M_{n,GPC}) of the P[DMAPS-co-MEL] random copolymers increases from 2.4×10⁴ to 2.7×10⁴ g/mol, as determined from gel permeation chromatography (GPC). The polydispersity index (PDI) of P[DMAPS-co-MEL] random copolymers remains at about 1.3, indicating RAFT polymerization of DMAPS and MEL from CTP is well-controlled. The molecular weight (M_{n,NMR}) of the P[DMAPS-co-MEL] random co-polymers can be also measured from ¹H NMR spectroscopy data (FIG. 13A), by comparing the ratio of protons in the phenyl groups (5H, i) of CTP tomethylene protons (2H, h) adjacent to the sulfonate groups in the PDMAPS chains, to inner methylene protons (2H, g′) the PMEL chains. TABLE 2 tabulates the above results.

TABLE 2
Characteristics of the P[DMAPS-co-MEL] Random Copolymers
Synthesized by RAFT Polymerization^{a}

| | | | | | | | | MEL |
|---|---|---|---|---|---|---|---|---|
| polymer | N_{DMAPS}^{b} | N_{MEL}^{b} | Time (h) | Conv. (%) | M_{n,GPC}^{c} | PDI^{c} | M_{n,NMR}^{d} | (mol %)^{d} |
| DM1 | 100 | 5 | 12 | 56 | 2.3 × 10⁴ | 1.26 | 1.7 × 10⁴ | 4.3 |
| DM2 | 100 | 5 | 24 | 81 | 2.9 × 10⁴ | 1.29 | 2.4 × 10⁴ | 5.1 |
| DM3 | 100 | 10 | 24 | 84 | 3.2 × 10⁴ | 1.34 | 2.6 × 10⁴ | 8.4 |
| DM4 | 100 | 15 | 24 | 82 | 3.4 × 10⁴ | 1.41 | 2.7 × 10⁴ | 13.6 |

^{a}DMAPS = [2-(methacryloyloxy)ethyl]dimethyl-(3-sulfopropyl)ammonium hydroxide, MEL = 2-methacryloyloxyethyl lipoate.
^{b}Target degree of polymerization of DMAPS or MEL
^{c}Determined from aqueous GPC results.
^{d}Determined from ¹H NMR spectroscopy results.

The M_{n,NMR} of P[DMAPS-co-MEL] random copolymers is lower than M_{n,GPC}. The use of poly(ethyleneglycol)(PEG) molecular weight standards for calibration in the GPC system may lead to a higher apparent molecular weight.

For comparison purposes, zwitterionic copolymers of 2-methacryloyloxyethylphosphorylcholine (MPC) and MEL (P[MPC-co-MEL] copolymers) with comparable molecular weights have been synthesized using reaction conditions similar to those used for the preparation of P[DMAPS-co-MEL] copolymers, as mentioned above. Reductive scission of the disulfide bonds in PMEL component was conducted using excess NaBH₄. The use of a NaBH₄/MEL molar ratio of 20:1 led to almost 100% cleavage within 2 h. The ¹H NMR spectroscopy confirmed the successful disulfide-to-thiol conversion, as the methylene protons adjacent to the disulfide groups (2H, k′ in FIG. 13A) in the PMEL chains shifted to higher field in the reduced form (2H, k′ in FIG. 13B).

Random copolymers with a [MEL]/[CTP] molar feed ratio of 5 (entry DM2 in TABLE 2 and entry MM2 in TABLE 3) were chosen for subsequent membrane surface coatings as a compromise for well-preserved water solubility and sufficient grafting sites (thiol groups from the PDMEL component).

TABLE 3
Characteristics of the P[MPC-co-MEL] Random Copolymers
Synthesized by RAFT Polymerization^{a}

| | | | | | | | | MEL |
|---|---|---|---|---|---|---|---|---|
| polymer | N_{MPC}^{b} | N_{MEL}^{b} | Time (h) | Conv. (%) | M_{n,GPC}^{c} | PDI^{c} | M_{n,NMR}^{d} | (mol %)^{d} |
| MM1 | 100 | 5 | 12 | 60 | 2.4 × 10⁴ | 1.31 | 1.9 × 10⁴ | 5.3 |
| MM2 | 100 | 5 | 24 | 85 | 3.1 × 10⁴ | 1.36 | 2.7 × 10⁴ | 4.5 |
| MM3 | 100 | 10 | 24 | 82 | 3.4 × 10⁴ | 1.28 | 2.8 × 10⁴ | 9.3 |
| MM4 | 100 | 15 | 24 | 86 | 3.8 × 10⁴ | 1.38 | 3.0 × 10⁴ | 12.4 |

^{a}MPC = 2-methacryloyloxyethyl phosphorylcholine, MEL = 2-methacryloyloxyethyl lipoate.
^{b}Target degree of polymerization of MPC or MEL.
^{c}Determined from aqueous GPC results.
^{d}Determined from ¹H NMR spectroscopy results.

### Example 15

### Preparation of the P[DMAPS-co-DMEL] and P[MPC-co-DMEL] Modified Hollow Fiber Membranes (Embodiment 2)

Spinning parameters of poly(ethersulfone) (PES) hollow fiber membranes were similar to that mentioned in Example 2 above.

The as-spun hollow fibers were then soaked in tap water to remove residual solvents for two days. Subsequently, the fibers were immersed in a 50/50 wt % glycerol/water solution for two days before drying in air at room temperature. Prior to polymer grafting, polydopamine-coated hollow fiber membrane was prepared. Two hundred milligram dopamine-HCl in a 1 L Tris buffer solution (0.01 mol L⁻¹, pH 8.5) was used to coat hollow fiber for 3 h.

After polydopamine (PDA) coating, zwitterionic polymers grafted hollow fibers were prepared by the Michael addition reaction between the PDA layer and P[DMAPS-co-DMEL] copolymers (or P[MPC-co-DMEL] copolymers). PES hollow fibers were soaked in a 10 g/L P[DMAPS-co-DMEL] aqueous solution containing triethylamine (TEA) of 1% (v/v) at room temperature. The amount of P[DMAPS-co-DMEL] copolymers was excessive and the reaction time was set at 24 h to ensure the completion of the coating (FIG. 14). After the reaction, the hollow fibers were washed and extracted thoroughly with copious amounts of doubly distilled water before characterization.

Dopamine has similar adhesive proteins as mussel. Comprising catechol and amine functional groups, it readily oxidizes in alkaline environments and undergoes self-polymerization to form an adherent polydopamine (PDA) gutter layer onto a wide range of supports, with oxidation of catechol groups to the quinine form. Numerous membranes have been constructed using dopamine as a transition layer. Another benefit of using dopamine is that the oxidized quinine form of catechol groups can react with various functional groups, including quinone, amine, and thiol, via Michael addition to covalently graft the functional layer. In the present study, the PDA coating and the Michael addition in aqueous media (i.e., the “grafting to” method) were employed to modify the poly(ether sulfone) (PES) hollow fibers.

### Example 16

### Polymer Characterization (Embodiment 2)

Analyses of the random copolymers by Fourier transform infrared (FTIR) spectroscopy were carried out on a Bio-Rad FTS 135 Fourier transform infrared spectrophotometer and the diffuse reflectance spectra were scanned over the range of 400-4000 cm⁻¹. The chemical structures of the synthesized monomer and random copolymers were characterized by ¹H NMR spectroscopy on a Bruker ARX 300 MHz spectrometer using CDCl₃ and D₂O as the solvents. Gel permeation chromatography (GPC) was performed on a Waters GPC system, equipped with a Waters 1515 isocratic HPLC pump, a Waters 717 plus Autosampler injector, a Waters 2414 refractive index detector, and a series of three linear Jordi columns (PLGel DVB 1000 Å, 300×7.5 mm, Cat. No. 79911GP-MXC, packed with 5 poly(divinylbenzene) particles), using water as the eluent at a flow rate of 1.0 mL/min at 50° C. A calibration curve was generated using poly(ethylene glycol) (PEG) molecular weight standards.

X-ray photoelectron spectroscopy (XPS) measurements were made on a Kratos AXIS Ultra DLD spectrometer with a monochromatized Al Kα X-ray source (1486.71 eV photons). Both wide scan and core-level spectra were measured. The core-level signals were got at the photoelectron take-off angle (α, with respect to the sample surface) of 90°. All binding energies (BEs) were referenced to that of the neutral C1s hydrocarbon peak at 284.6 eV. In peak synthesis, the line width for the Gaussian peaks was maintained constant for all components in a particular spectrum. Surface elemental stoichiometry was determined from peak-area ratios, after correcting with the experimentally determined sensitivity factors, and were reliable to 75%. The morphology of membranes was studied by field emission scanning electronic microscopy (FESEM, JEOLJSM-6700F) or scanning electron microscopy (SEM, JEOL JSM-5600LV). Before SEM/FESEM tests, the samples were freeze-dried and prepared in liquid nitrogen.

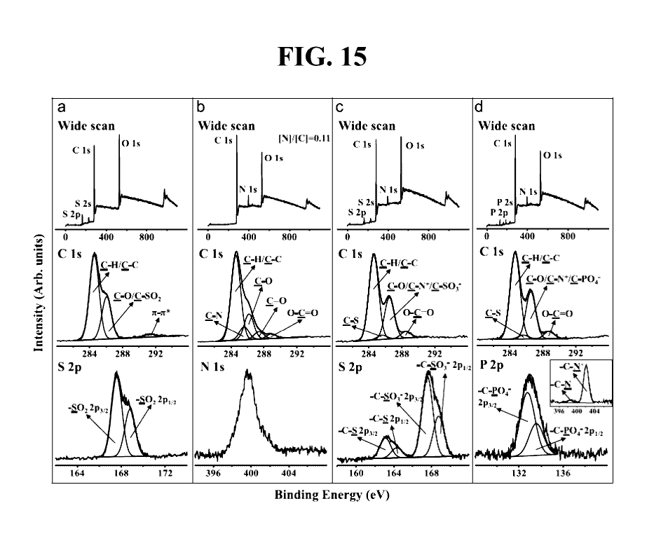

FIG. 15 exhibits the respective X-ray photoelectron spectroscopy (XPS) widescan, C1s, N1s, S2p and P2p core-level spectra of outer surfaces of (a) PES, (b) PES-PDA, (c) PES-g-P[DMAPS-co-DMEL], and (d) PES-g-P[MPC-co-DMEL] membranes.

In the case of the pristine PES membrane, C 1s, O 1s, S 2s and S 2p signals are observed in the wide-scan spectrum (FIG. 15a). The C 1s core-level spectrum can be split into three peak components with binding energies (BEs) at about 284.6, 286.1 and 291.3 eV, attributable to the C—H/C—C, C—O/C—SO₂ and π-π* shake-up species, respectively (FIG. 15a). The area ratio of about 2:1 for the [C—H/C—C]/[C—O/C—SO₂] peak component is consistent with the chemical structure of PES. The S 2p core-level spectrum shows a strong spin-orbit split doublet with BEs for the —SO₂ 2p_{3/2} and —SO₂ 2p_{1/2} peak components at 167.6 and 168.8 eV, respectively (FIG. 15a). After PDA treatments, the appearance of distinctive N1s signal at the BE of about 400 eV and the disappearance of S 2p signal at the BE of about 168 eV in the wide-scan spectrum indicate that the PDA layer has exceeded the sampling depth of the XPS techniques (about 8 nm in an organic matrix) (FIG. 15b). The C 1s core-level spectrum of PES-PDA membrane can be curve-fitted into five peak components with BEs at about 284.6, 285.6, 286.2, 287.4 and 288.9 eV, assigned to the C—H/C—C, C—N, C—O, C═O, and O—C═O species, respectively (FIG. 15b). The [N]/[C] ratio of the PES-PDA membrane is 0.11, which is comparable to the theoretical value of 0.12 for dopamine.

The P[DMAPS-co-DMEL] and P[MPC-co-DMEL] random copolymers were grafted onto the PES-PDA membranes via Michael reaction to impart antifouling properties. As shown in FIG. 15c, the presence of DMEL grafting is ascertained by the XPS wide scan, C 1s and S 2p spectra. The appearance of S 2p and S 2s signals in the wide-scan spectrum (FIG. 15c) of PES-g-P[DMAPS-co-DMEL] membrane is consistent with the presence of PDMAPS brushes on the PES-g-P[DMAPS-co-DMEL] membrane. The C is core-level spectrum of the PES-g-P[DMAPS-co-DMEL] membrane can be curve-fitted into four peak components with BEs at 284.6 eV for the neutral C—H/C—C species, 285.6 eV for the C—S species, 286.5 eV for the C—O/C—N⁺/C—SO₃⁻ species and 288.5 eV for the O═C—O species (FIG. 15c). Two spin-orbit split doublets are discernible in the S 2p core-level spectrum. The S 2p doublet, with the SO₃⁻ 2p_{3/2} and SO₃⁻ 2p_{1/2} peak components at the BEs of 163.1 and 164.3 eV, respectively, confirms the formation of a normal C—S bond. On the other hand, another S 2p doublet at the BEs of 167.5 and 168.7 eV can be assigned to the sulfonate C—SO₃⁻ species (FIG. 15c).

Similarly, the presence of PMPC brushes on the PES-g-P[MPCco-DMEL] membrane is ascertained by the XPS widescan, C 1s, N 1s and P 2p core-level spectra of the PES-g-P[MPC-co-DMEL] membrane (FIG. 15d). The C is core-level spectrum of the PES-g-P[MPC-co-DMEL] membrane can be curve-fitted into four peak components with BEs at 284.6 eV for the neutral C—H/C—C species, 285.6 eV for the C—S species, 286.5 eV for the C—O/C—PO₄⁻/C—N⁺ species and 288.7 eV for the O═C—O species (FIG. 15d). The appearance of the P 2p core-level spectrum is consistent with the existence of PMPC brushes on the PES-g-P[MPC-co-DMEL] membrane. The P 2p core-level spectrum consists of the PO₄⁻ 2 p_{3/2} and PO₄⁻ 2p_{1/2} peak components of the phosphate species at BEs of about 132.8 and 133.6 eV, respectively (FIG. 15d). The same result can also be deduced from the change in the N 1s core-level line shape of the PES-g-P[MPC-co-DMEL] membrane (inset of FIG. 15d).

The spectrum is dominated by the peak component at a BE of about 402 eV, due to the positively charged nitrogen (—N⁺) species from the graft PMPC chains.

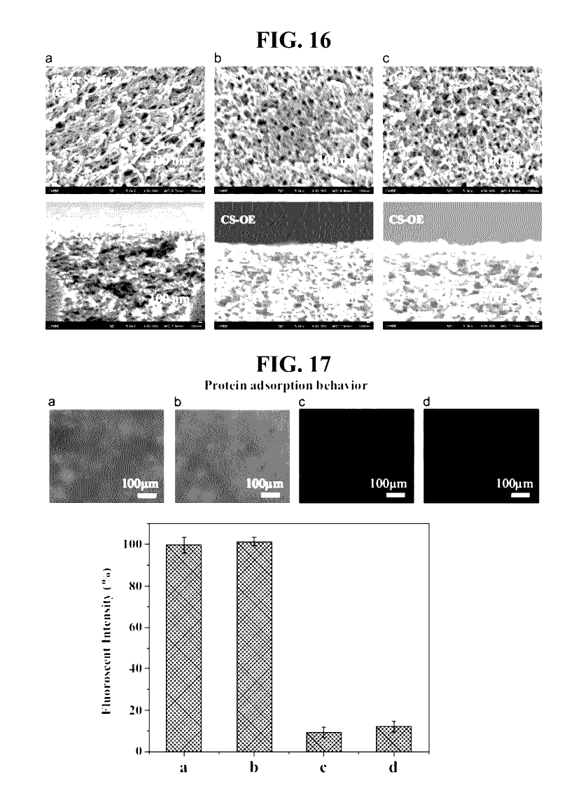

The morphologies of (a) PES, (b) PES-g-P[DMAPS-co-DMEL], and (c) PES-g-P[MPC-co-DMEL] membranes studied by FESEM are shown in FIG. 16. The high porosity of the outer surface remains almost the same after grafting. All membranes also show similar cross-section morphologies indicating the PDA modification and subsequent copolymer grafting have no visible effects on membrane structure.

### Example 17

### Anti-Fouling Assays (Embodiment 2)

Both Gram-positive S. epidermidis (ATCC35984) and Gram-negative E. coli (ATCCDH5α) were cultured to determine the antibacterial adhesion characteristics and bactericidal efficiency of the polymer-functionalized hollow fiber membranes. Sterilization was conducted prior to bacterial attachment tests. All glassware and culture media were autoclaved at 120° C. for 20 min, and the samples of 1 cm in length were UV-irradiated for 30 min before use. S. epidermidis and E. coli were cultured in the tryptic soy broth and nutrient broth, respectively, at 37° C. overnight. The bacterial culture broths were centrifuged at 2700 rpm for 10 min. After removal of the supernatant, the bacteria cells were washed with PBS twice and resuspended in PBS (pH 7.4) at a concentration of 5×10⁷ cells/mL. The spread plate counting was conducted to estimate the bacterial concentrations. An optical density of 1.0 at 540 nm in the suspension was equivalent to 10⁹ cells/mL.

Membranes were then individually immersed in the bacterial suspension at 37° C. for 4 h. After incubation, the membranes were washed thrice with PBS to remove the loosely and free bacteria.

The adhered bacteria were fixed with 3% (v/v) aqueous glutaraldehyde at 4° C. overnight, followed by serial dehydration in 20%, 40%, 60%, 80% and 100% ethanol for 10 min each. The membranes were then dried by vacuum and imaged by SEM as the qualitative imaging. Quantification of bacteria adhesion and viability on pristine and polymer-functionalized membranes was carried out by the spread plate method. The bacterial-adhered membranes were washed in 2 mL sterile PBS under mild ultrasonication for 7 min, followed by a rapid vortex mixing for 20 s, to release the attached bacteria cells from the membrane surface.

After 10-fold serial dilution of the bacterial solution, a 100 mL aliquot was spread on to the plate containing the culture medium and the bacteria were incubated at 37° C. overnight. At last, the grown cell colonies were counted on the spread plate and presented as the relative viability of bacteria on membranes.

To determine the antifouling efficacy of the functionalized hollow fiber membrane surfaces, protein adsorption was performed using fluorescein isothiocynate conjugated bovine serum albumin (BSA-FITC). The BSA-FITC was dissolved in phosphate buffered saline (PBS, 10 mM, pH 7.4) with a concentration of 0.5 mg/mL. The membranes were rinsed with PBS to rehydrate the surfaces. All the samples were then immersed in the BSA-FITC solution at 37° C. for 2 h. They were then removed from the protein solution, gently washed three times with PBS. The adsorption of BSA-FITC on the membrane surfaces was imaged with a Leica DMLM fluorescence microscope (Leica Microsystems, Wetzlar, Germany), equipped with an excitation filter of 495 nm and an emission filter of 525 nm. The fluorescence intensity, which was proportional to the surface density of adsorbed BSA-FITC proteins, was quantified using ImageJ software (National Institutes of Health, Bethesda, Md., U.S.A.).

The cytotoxicity of polymer-functionalized hollow fiber membranes was evaluated via 3-(4,5-dimethylthiazol-2-yl)-2,5-diphenyltetrazoliumbromide (MTT) assay in the mouse 3T3 fibroblasts cell line. The membranes were first sterilized with 75% ethanol and dried under a reduced pressure before use. The cytotoxicity of membranes was evaluated by determining the viability of 3T3 fibroblasts after incubating in the medium with the membranes.

The 3T3 fibroblasts were seeded in a 24-well culture plate and incubated at 37° C. for 24 h in the medium. Then, the medium was replaced with a fresh medium containing different samples of 1 cm in length. Control experiments were carried out using the complete growth culture medium without the membranes. The 3T3 fibroblasts were incubated for another 24 h in the medium.

After that, the culture medium in each well was removed and 90 mL of the medium and 10 mL of the MTT solution (5 mg/mL in PBS) were then added to each well. After 4 h of incubation at 37° C., the medium was removed and the formazan crystals (a purple-color dye from reduction of MTT in living cells) were solubilized with 100 mL dimethyl sulfoxide (DMSO) for 15 min. The optical absorbance was measured at 560 nm on a microplate reader (Tecan GENios). The results were expressed as percentages relative to that obtained in the control experiment.

The resistance against protein adsorption is one of the dominant factors in evaluating the antifouling performance of membranes. To qualitatively examine the protein resistance on surface functionalization, the membranes were soaked in the fluorescein-labeled BSA protein solution (BSA-FITC).

FIG. 17 compares the relative fluorescence intensities and fluorescence microscopy images among the pristine PES membrane and modified ones of PES-PDA, PES-g-P[DMAPS-co-DMEL], and PES-g-P[MPC-co-DMEL] after exposure to a 0.5 mg/mL PBS of BSA-FITC for 2 h. Large amount of BSA molecules cover the surface of the pristine PES membrane because of the hydrophobic-hydrophobic interactions between conjugated benzene rings of PES and protein molecules. The PES-PDA membrane surface has a comparative amount of BSA adsorption arising from attraction between the possible π-π stacking of the PDA layer and BSA molecules. Therefore, the fluorescence on the PES-PDA membrane surface is also uniform with high intensity. The BSA adsorptions significantly decrease on the zwitterionic polymers modified PES membrane surfaces. The fluorescence intensities drop more than 90%. The protein repellent capacity of PDMAPS and PMPC brushes is likely associated with the unique properties of charged units. It was demonstrated that superhydrophilic zwitterionic polymers can take up a large quantity of water molecules and thus consequently form a surface hydration layer that possibly prevents protein molecules from close contact with the membrane surfaces and irreversible fouling.

The decay in membrane performance, arising from microbial adhesion onto membrane surfaces and subsequent formation of biofilms are critical issues in water treatment. In this study, Gram-positive S. epidermidis and Gram-negative E. coli were used to assess the bacterial adhesion efficacy of the modified surfaces.

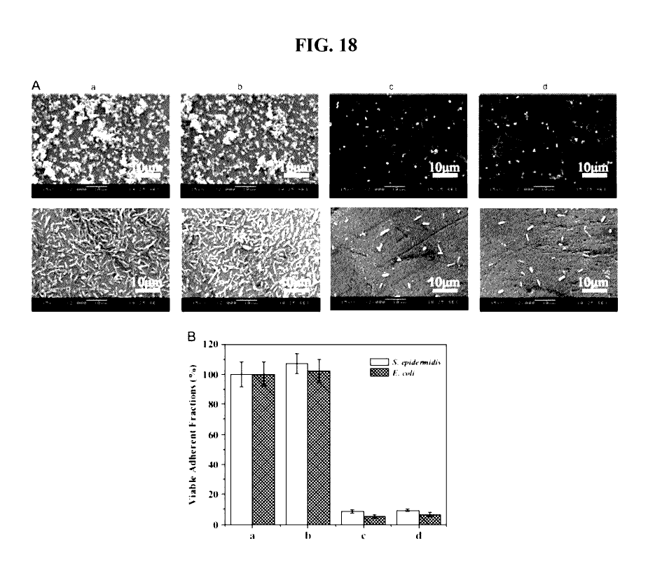

An incubation time of 4 h was utilized, which was sufficient for bacteria to achieve the initial adhesion state on a substrate. In comparison to the E. coli inoculated membrane, the SEM micrographs show that S. epidermidis form much thicker and more uniform biofilms on the PES and PES-PDA membrane surface (FIG. 18A). This result agrees well with the earlier reports that S. epidermidis (ATCC 35984) has a strong biofilm formation ability. On the other hand, very sparse bacteria cells were observed for the PES-g-P[DMAPS-co-DMEL] and PES-g-P[MPC-co-DMEL] membrane surfaces. The bacteria cells which were killed upon contact with the quandary ammonium salts from PDMAPS and PMPC hydration layers were loosely attached to the surface and were washed away by simple physical cleaning, leaving behind much cleaner membrane surfaces. The above results reveal that the PES-g-P[DMAPS-co-DMEL] and PES-g-P[MPC-co-DMEL] membranes are of high efficiency in preventing bacterial adhesion, growth, and proliferation and thus biofilm formation.

FIG. 18B shows the quantitative assay of bacterial attachment on the membrane surface using the spread plate method. The PES-PDA membrane surface was more susceptible to bacterial adhesion in comparison with the pristine PES membrane, with the relative viability of S. epidermidis and E. coli increasing to 107% and 102%, respectively. In general, a larger surface area arising from the rougher and heterogeneous surface provided by the PDA coating layer, allow the bacteria to cling onto the surface more tightly. In contrast, the PES-g-P[DMAPS-co-DMEL] and PES-g-P[MPC-co-DMEL] membrane surfaces reduced S. epidermidis adhesion to 8% and 9%, and E. coli adhesion to 5% and 7%, respectively.

From a safety point of view, the membranes used in PRO processes for the concentrated municipal wastewater treatment should be strictly non-toxic in nature to avoid any secondary contamination. As disclosed herein, the cytotoxicity of the as-functionalized membranes was evaluated via the in vitro experiments of the 3-(4,5-dimethylthiazol-2-yl)-2,5-diphenyltetrazoliumbromide (MTT) cell viability assay in the mouse 3T3 fibroblasts cell line. The 3T3 fibroblasts were incubated with membranes for 24 h.

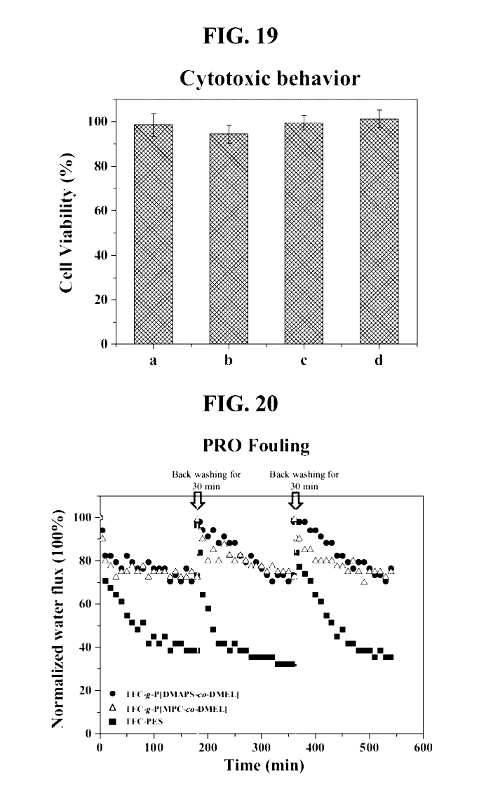

The results show that both the PES-g-P[DMAPS-co-DMEL] and PES-g-P[MPC-co-DMEL] membranes exceed 98% for the viability of 3T3 fibroblasts cell in comparison of the control experiment (FIG. 19), indicating that the introduction of PDMAPS and PMPC brushes onto the PES membrane surface has negligible cytotoxicity effect to viable cells. On the other hand, the slightly higher viability of cells (94%) on the PES-PDA membrane surface may be attributed to the toxicity of residual imine groups in the PDA gutter layer.

### Example 18

### Fabrication of Thin-Film Composite (TFC) Membrane by Interfacial Polymerization of the Hollow Fiber Membranes (Embodiment 2)

Thin-film composite (TFC) polyamide membranes were synthesized on the inner surface of the respective pristine and polymer grafted hollow fiber supports mentioned above via interfacial polymerization of m-phenylenediamine (MPD) in aqueous phase and 1,3,5-benzenetricarbonyl trichloride (TMC) in organic phase (n-hexane) via the following procedures: (1) the membrane module was held vertically and purged by compressed air to sweep impurities on the inner surface of hollow fibers; (2) a MPD solution of 2 wt % was introduced to the inner surface of hollow fiber supports vertically from bottom to top at a flow rate of 2.2 ml min⁻¹ for 3 min; (3) the excess MPD aqueous solution was removed by purging with compressed air for 5 min; (4) a hexane solution containing 0.15 wt % TMC was fed to the inner face of the fibers with a flow rate of 2.2 ml min⁻¹ for 5 min followed by a 15-min heat treatment in an oven at 65° C. Finally, the resultant TFC membrane was washed thoroughly with de-ionized water and stored in de-ionized water before tests.

### Example 19

### Membrane Fouling Tests in PRO Processes (Embodiment 2)

A laboratory-scale PRO setup was employed for the PRO fouling tests. To examine the actual antifouling performance of the zwitterionic polymers grafted hollow fiber membranes, RO retentate from a municipal water recycling plant was used as the feed solution as disclosed herein. The concentrated wastewater is a rich source of dissolved ions, organic compounds and biopolymers.

Synthetic brine (1 mol/L NaCl) and concentrated wastewater were used as draw and feed solutions, respectively. A variable-speed peristaltic pump (Cole-Palmer, Vernon Hills, Ill.) was used to recirculate the feed solution through the shell side of the hollow fibers, and a high-pressure hydracell pump to re-circulate the draw solution through the lumen side. Counter-current flows at a flow rate of 0.1 L/min were applied to both sides.

The fouling experiments were performed at 10.0±0.5 bar for the TFC-PES, TFC-g-P[DMAPS-co-DMEL] and TFC-g-P[MPC-co-DMEL] hollow fiber membranes. In all tests, the selective layer of TFC membranes was placed against the draw solution. Prior to tests, the TFC hollow fiber membranes were stabilized at a hydraulic pressure of 10±0.5 bar for 0.5 h. An initial water flux was obtained under the same conditions in the absence of foulants. Membrane backwashing was performed by feeding deionized water into the lumen side of the hollow fibers at a pressure of 10±0.5 bar while rinsing the shell side of the hollow fibers with deionized water at 0 bar. The water permeation flux J_{w} (L/m² h) was determined by the driving force and membrane resistance.

J_{w}=A(Δπ−ΔP)

where A is the water permeability coefficient (L/m² h bar), Δπ is the osmotic pressure across the membrane (bar), ΔP is the hydrostatic pressure across the membrane (bar). The theoretical osmotic power density, W (W/m²), is determined by

W=ΔP·A(Δπ−ΔP)=ΔP˜J_{w}

where J_{w} is defined as the flux across the membrane, and the membrane power density W is a function of the available trans-membrane pressure and the flux. With a particular osmotic pressure and a hydrostatic pressure applied, antifouling modifications that could reduce membrane resistance will increase water flux, and thus increase the power density.

FIG. 20 shows the fouling and recovering effects of the TFC membranes. The normalized water flux (i.e., normalizing it to the initial flux in the absence of foulants) is plotted against testing time. When the TFC-PES (rectangular dots) membrane was subjected to a wastewater feed solution, the water flux immediately and substantially declined within the first 5 min. Then the water flux gradually dropped to about 40% of the initial flux at 90 min; after that, a slow decline was observed and a high reduction of 61.3% in water flux was found at the end of test. The significant flux drop suggests a serious fouling propensity of the pristine PES membrane owing to its inherent susceptibility by foulants.

In comparison, the TFC-g-P[DMAPS-co-DMEL] membrane exhibited a slow reduction in water flux over the first 40 min. Subsequently the flux remained almost constant in a small range of 70-79% throughout the experimental run. The TFC-g-P[MPC-co-DMEL] membrane also showed a similar performance during the testing duration. Eventually, these two membranes have much lower reductions in water flux in the range of 27.5-28.5% owing to the formation of surface hydration layers induced by the zwitterionic polymers.

After fouling tests, backwashing by deionized water was performed on the draw solution side of the membrane at 10 bar for 0.5 h. The cleaned membranes were retested under the same conditions. In all cases of membranes, the flux recoveries are higher than 96%. In the second and third runs, all TFC membranes showed a similar water reduction as well recovery as in the first run. Clearly, the zwitterionic polymers grafted onto hollow fiber membranes achieve good antifouling performance (TABLE 4).

TABLE 4
Comparisons of fouling performance of PRO membranes.

| | | Water | | | | | |
|---|---|---|---|---|---|---|---|
| | Water flux | flux | Feed | Draw | Operating | | |
| Membrane | reduction | recovery | solution | solution | pressure | | Reference |
| TFC-g- | 27.5~28.5% | >96% | Real | 1M NaCl | 10 | bar | This |
| P[DMAPS-co-DMEL] | | | wastewater | | | | work |
| hollow fiber | | | | | | | |
| TFC-g- | 27.5~28.5% | >96% | Real | 1M NaCl | 10 | bar | This |
| P[MPC-co-DMEL] | | | wastewater | | | | work |
| hollow fiber | | | | | | | |
| TFC-PES | 61.3% | >96% | Real | 1M NaCl | 10 | bar | This |
| hollow fiber | | | wastewater | | | | work |
| TFC-PES | 40~60% | — | Synthetic | 1M NaCl | 8-18 | bar | (5) |
| hollow fiber | | | wastewater | | | | |
| HTI-CTA | ~25% | ~90% | Synthetic | Synthetic | 10 | bar | (6) |
| flatsheet | | | wastewater | seawater | | | |
| HTI-CTA | ~30% | ~90% | Synthetic | Brine | 10 | bar | (6) |
| flatsheet | | | wastewater | | | | |
| TFC-HPG | 11% | ~94% | Protein | Synthetic | 12.5 | bar | (7) |
| hollow fiber | | | solution | seawater | | | |

### REFERENCES

(5) S. C. Chen, C. F. Wan, T. S. Chung, Enhanced fouling by inorganic and organic foulants on pressure retarded osmosis (PRO) hollow fiber membranes under high pressures. Journal of Membrane Science 479 (2015) 190-203.
(6) D. I. Kim, J. Kim, H. K. Shon, S. Hong, Pressure retarded osmosis (PRO) for integrating seawater desalination and wastewater reclamation: Energy consumption and fouling. Journal of Membrane Science 483(2015) 34-41.
(7) X. Li, T. Cai, T. S. Chung, Antifouling behavior of hyperbranched polyglycerol-grafted poly(ether sulfone) hollow fiber membranes for osmotic power generation. Environ. Sci. Technol., 48 (2014) 9898-9907.

It is worthwhile to note that the PES-g-P[DMAPS-co-DMEL] and PES-g-P[MPC-co-DMEL] membrane surfaces are highly effective in preventing not only protein attachment, bacterial adhesion, but also inorganic deposition.

Water-soluble zwitterionic random copolymers with thiol-functionalized PDMEL segments, P[DMAPS-co-DMEL] (or P[MPC-co-DMEL]), were synthesized through RAFT polymerization of DMAPS (or MPC) and MEL, followed by reductive scission of disulfide groups in PDMEL chains with excess NaBH₄. The zwitterionic copolymers were then linked to the PDA pretreated PES hollow fiber membranes via Michael addition. The as-functionalized PES hollow fiber membranes grafted with superhydrophilic PDMAPS and PMPC brushes exhibited improved fouling resistance to protein and bacterial adhesion with minimum alteration of their morphology and bulk properties. Cytotoxicity experiments further confirm then on toxicity of the zwitterionic polymers grafting.

Moreover, the zwitterionic polymers grafted TFC membranes achieve higher water flux in PRO tests in comparison to the pristine TFC-PES membrane. The reduction in water flux is as low as about 27% of the initial value for fresh TFC-g-P[DMAPS-co-DMEL] and TFC-g-P[MPC-co-DMEL] membranes, compared to about 61% for the TFC-PES membrane. This pioneering work provides a versatile approach for the design and fabrication of antifouling PRO membranes in molecular level.

Fouling on pressure retarded osmosis (PRO) membranes must be eliminated to maximize the efficiency of osmotic power generation. This is particularly applicable to PRO membranes due to its nature of fouling when wastewater is fed. To improve this, PRO thin-film composite (TFC) membranes for the first time have been redesigned by incorporating well-defined zwitterionic copolymers of [2-(methacryloyloxy)ethyl]dimethyl-(3-sulfopropyl)ammonium hydroxide (DMAPS) or 2-methacryloyloxyethyl phosphorylcholine (MPC) onto the poly(ether sulfone) (PES) hollow fiber membranes. The introduction of 2-methacryloyloxyethyl lipoate (MEL) components into the zwitterionic copolymers provided sufficient grafting sites for the facile decoration of polydopamine (PDA) pretreated PES membranes via Michael addition. The PDMAPS and PMPC grafted membranes were shown to be effective in reducing protein adsorption and bacterial adhesion, in comparison to the pristine PES membranes and PDA pretreated membranes. The pristine TFC-PES membranes are fouled greatly in high pressure PRO tests with concentrated wastewater, resulting in a flux reduction of 61%. In contrast, the TFC-PES membranes grafted by zwitterionic PDMAPS and PMPC copolymers exhibit substantial improvement of flux recovery up to 98% after backwashing and hydraulic pressure impulsion. In summary, the osmotic power generation may be sustained by grafting the PRO membranes with the properly designed zwitterionic polymers

### Example 20

### Synthesis of CHPG-SH (Embodiment 3)

CHPG-SH was synthesized based on HPG polymer from ring-opening polymerization of glycidol, using BHEDS as the initiator and sodium methoxide as the catalyst. An esterification step was conducted on the synthesized HPG, to introduce carboxylic ending groups and disulfide bonds (S—S); The CHPG-S—S polymer was dried under vacuum at 80° C. to give a highly viscous liquid. And then it was dissolved in N,N-dimethylformamide (DMF). The reaction mixture was purged with argon for 30 min. DTT was then introduced into the reaction flask. The mixture was stirred under the protection of an argon stream for 24 h at 50° C. The crude product was dialyzed against deionized water for 3 days, with the deionized water changed twice daily, using a cellulose acetate dialysis tubing. Finally, the CHPG-SH polymer was obtained a yellow liquid.

### Example 21

### Preparation of the CHPG Grafted Hollow Fiber Membrane Embodiment 3

Prior to polymer grafting, polydopamine-coated TFC hollow fiber membrane was prepared. Two hundred milligram dopamine-HCl in a 1 L Tris buffer solution (0.01 mol pH 8.5) was used to coat hollow fiber for 3 h. After polydopamine (PDA) coating, CHPG grafted hollow fibers were prepared by reaction between polydopamine and CHPG-SH. PES hollow fibers were soaked in a 10 g L⁻¹ CHPG-SH water solution containing triethylamine (TEA) of 0.7%, v/v at room temperature. The amount of CHPG was excessive and the reaction time was 12 h to ensure the completion of the coating.

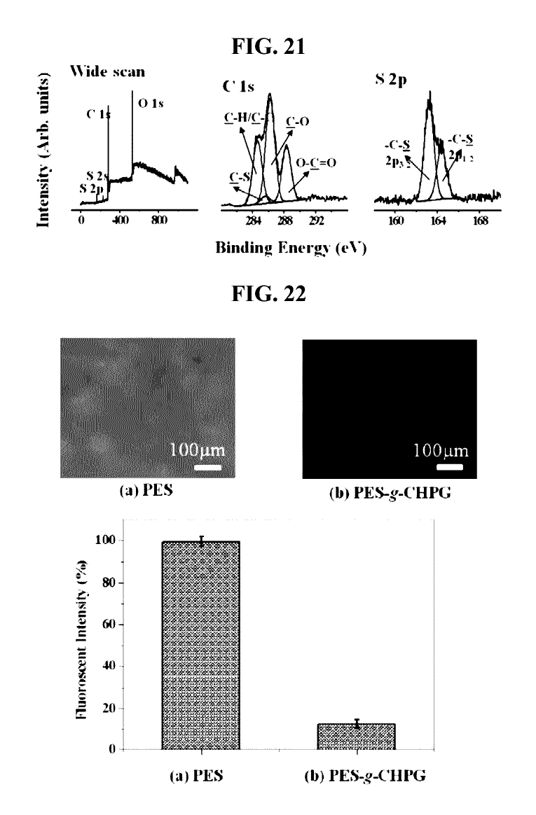

As shown in FIG. 21, the presence of CHPG grafting is ascertained by the XPS wide scan, C 1s and S 2p spectra. The appearance of S 2s and S 2p signals in the wide scan is consistent with the sulfur site of the CHPG polymer. The C 1s core-level spectrum consisting of the O—C═O species also shows the carboxylic groups of grafted CHPG segments.

### Example 22

### Anti-Fouling Assays (Embodiment 3)

FIG. 22 shows relative fluorescence intensities and respective fluorescence microscopy images of PES, and PES-g-CHPG grafted hollow fiber membrane supports after exposure to 0.5 mg mL⁻¹ BSA-FITC solution for 1 h. Scale bar in the figures denote 100 μm. For the CHPG grafted surface, the fluorescence intensity is only 13% of that on the pristine PES surface.

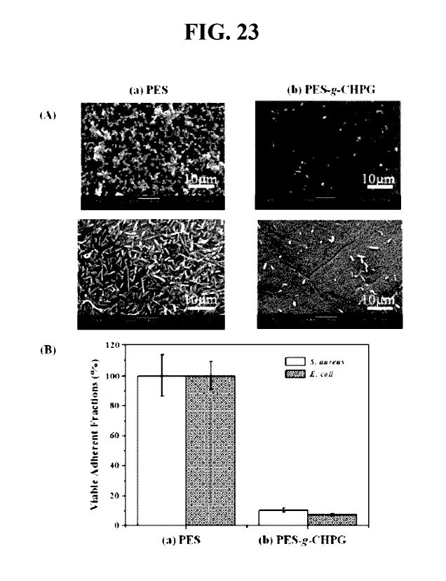

FIG. 23 shows SEM images of outer surfaces of (a) PES and (b) PES-g-CHPG hollow fibers after exposure to S. aureus (top) and E. coli (below) at an initial cell concentration of 5×10⁷ cells/mL for 4 h at 37° C. The cell number was determined by the spread plate method.

For the CHPG grafted membrane, the amount of E. coli adhesion decreases monotonically after polymer modifications, with a viable adherent fraction of 7.3% to that of the pristine PES membrane. On the other hand, after S. aureus exposure, the CHPG grafted membranes reduce the adhesion to 10.3%, respectively, in comparison to the pristine PES membrane.

### Example 23

### Membrane Fouling Tests for the CHPG Membranes (Embodiment 3)

The PRO fouling tests were conducted on a lab-scale PRO set-up at 15 bar. Synthetic seawater brine (0.8 M NaCl) and municipal wastewater were used as draw and feed solutions, respectively. TFC membranes were oriented in the PRO mode (i.e., selective layer faces the draw solution) for all tests. Counter-current flows at a flow rate of 0.1 L min⁻¹ were applied to both the draw solution and the feed solution at 24±1° C.

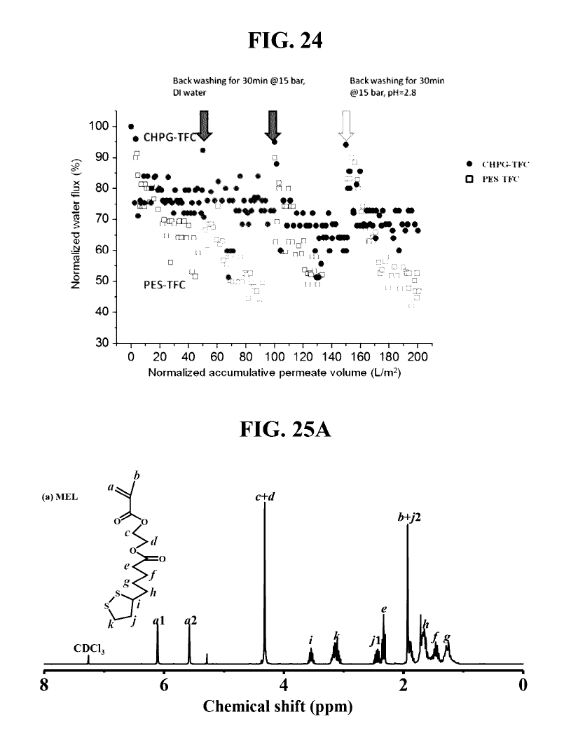

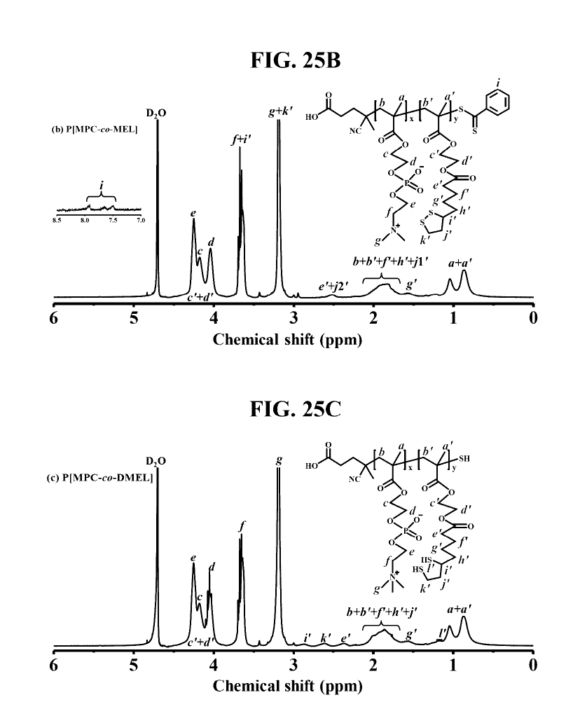

Municipal wastewater was chosen as the feed solution during PRO tests. FIG. 24 demonstrates the fouling and recovering behaviors of the TFC membranes. The rectangular symbols indicate the normalized water flux of the plain TFC membrane during the fouling test as a function of normalized cumulative permeate volume. In comparison, CHPG-TFC membranes were also studied. A steep water flux decrease was found in the early stage of the fouling test. Then the fouling progressively deteriorated the membrane performance, with a normalized flux dropping to about 67% at the end of the fouling test, suggesting an antifouling effect to municipal wastewater of the CHPG-grafted membrane.

Various embodiments refer to a membrane, comprising of a polymer grafted onto its surface, wherein the polymer confers an anti-fouling characteristic on the membrane. The polymer grafted may be hyperbranched, and may further be functionalized. The hyperbranched polymer may be hydrophilic or hydrophobic.

The polymer may be a co-polymer, and the membrane surface may be organic or inorganic. Water flux recovery rate of the inventive membrane may be more than 85%.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A membrane assembly comprising
a) a membrane having a first surface and an opposing second surface, and
b) a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof arranged on the first surface of the membrane.

2. The membrane assembly according to claim 1, wherein the hyperbranched polyglycerol is obtainable by reacting glycidol with a disulfide initiator to form a polymer, and reacting the polymer with a reducing agent to obtain the hyperbranched glycerol.

3. The membrane assembly according to claim 2, wherein the disulfide initiator is bis(2-hydroxyethyl)disulfide and the reducing agent is DL-1,4-dithiothreitol.

4. The membrane assembly according to claim 1, wherein the hyperbranched polyglycerol is a functionalized hyperbranched polyglycerol comprising a functional group selected from the group consisting of a carboxylic group, a sulfonate group, a phosphate group, a quaternary ammonium group, a phosphonium group, and combinations thereof.

5. The membrane assembly according to claim 1, wherein the hyperbranched polyglycerol has a structure as depicted in general formula (I)

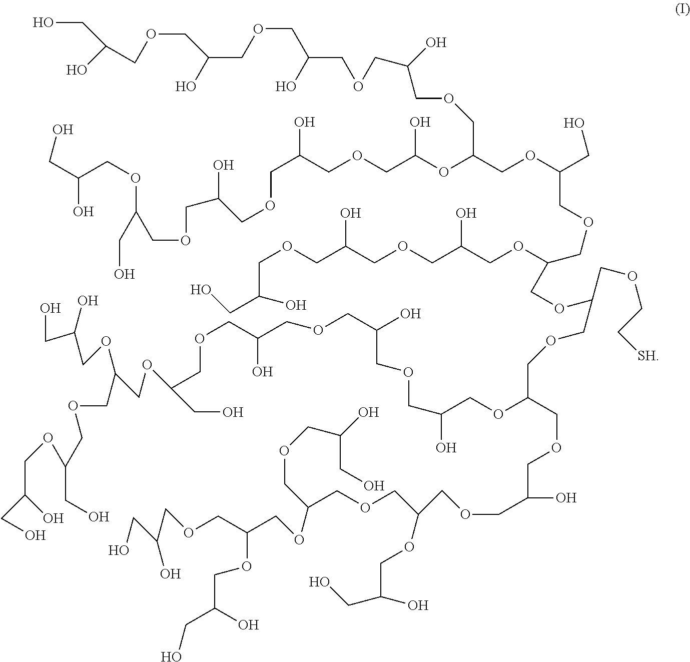

6. The membrane assembly according to claim 1, further comprising a linking layer arranged between the membrane and the layer of anti-fouling polymer for immobilizing the layer of anti-fouling polymer to the membrane.

7. The membrane assembly according to claim 6, wherein the linking layer comprises polydopamine.

8. The membrane assembly according to claim 1, wherein the membrane comprises a material selected from the group consisting of polyethersulfone, polysulfone, polyvinylidene fluoride, cellulose acetate, matrimid, Torlon, polyetherimide, polyacrylonitrile, ceramic materials, and combinations thereof.

9. The membrane assembly according to claim 1, further comprising a polyamide layer arranged on the second surface of the membrane.

10. The membrane assembly according to claim 1, wherein the membrane is a multi-layer hollow fiber membrane.

11. The membrane assembly according to claim 10, wherein the layer of anti-fouling polymer forms an outer layer of the multi-layer hollow fiber membrane.

12. The membrane assembly according to claim 1, for producing osmotic energy in pressure retarded osmosis.

13. A method of manufacturing a membrane assembly, the method comprising
a) providing a membrane having a first surface and an opposing second surface, and
b) arranging a layer of anti-fouling polymer selected from the group consisting of an optionally functionalized hyperbranched polyglycerol, a hyperbranched polyimine, a zwitterionic copolymer obtainable by polymerizing 2-methacryloyloxyethyl lipoate with at least one of [2-(methacryloyloxy)ethyl]dimethyl-(3-sulfopropyl) ammonium hydroxide or 2-methacryloyloxyethylphosphorylcholine, and combinations thereof on the first surface of the membrane.

14. The method according to claim 13, wherein providing the membrane comprises depositing a linking layer for immobilizing the anti-fouling polymer on a first surface of the membrane.

15. The method according to claim 14, wherein the linking layer comprises polydopamine.

16. The method according to claim 14, wherein arranging the layer of anti-fouling polymer on the first surface of the membrane comprises depositing the layer of anti-fouling polymer under conditions to immobilize the anti-fouling polymeric layer on the linking layer.

17. The method according to claim 13, wherein providing the membrane comprises forming a polyamide layer on the second surface of the membrane.

18. The method according to claim 17, wherein forming the polyamide layer is carried out by interfacial polymerization of a polyfunctional amine in an aqueous phase and a polyfunctional acyl chloride in an organic phase.
